(19) United States
(12) Patent Application Publication
(10) Pub. No.: US 2019/0032726 A1
(43) Pub. Date: Jan. 31, 2019

(54) Master Mounting and Hydraulic Disk Brake

(71) Applicant: Gustav Magenwirth GmbH & Co., Bad Urach (DE)

(72) Inventors: Michael Ruopp, Berghülen (DE); Hubert Eberlein, Metzingen (DE); Joachim Hujer, Grabenstetten (DE); Reiner Künstle, Metzingen (DE); Jürgen Beier, Ulm (DE); Stefan Ruckh, Roemerstein (DE)

(73) Assignee: Gustav Magenwirth GmbH & Co., Bad Urach (DE)

(21) Appl. No.: 16/151,964

(22) Filed: Oct. 4, 2018

Related U.S. Application Data
(62) Division of application No. 15/845,266, filed on Dec. 18, 2017.
Application No. 15/845,266 is a continuation of application No. 13/777,571, filed on Feb. 26, 2013, now abandoned.
Application No. 13/777,571 is a continuation of application No. PCT/EP2011/064673, filed on Aug. 25, 2011.

(30) Foreign Application Priority Data
Aug. 26, 2010 (DE) 10 2010 035 492.9
Aug. 31, 2010 (DE) 10 2010 040 045.9

(51) Int. Cl. F16D 25/08; F16D 65/12; B60T 11/16; B60T 17/04; B62L 1/00; B62L 3/02; F16B 35/04; F16D 55/228; B60T 7/10; B60T 17/22; F16D 1/06; F16D 55/00; F16D 65/02; F16D 121/04; F16D 125/16

(52) U.S. Cl. CPC F16D 25/088; F16D 2055/002; B60T 11/16; B60T 17/04; B60T 17/043; B62L 1/005; B62L 3/023; F16B 35/041; F16D 55/228; B60T 7/102; B60T 17/222; F16D 2001/062; F16D 2025/081; F16D 2055/0008; F16D 2300/18; F16D 2065/1316; F16D 2065/1392; F16D 2121/04; F16D 2125/16; F16D 65/12

(57) ABSTRACT

A master cylinder for a hydraulic brake or clutch, the master cylinder comprising a lever and a cylinder housing in which a piston is slidably arranged, wherein the piston is secured against rotation in the cylinder housing, and a piston position detection device having a signal member asymmetrically arranged with respect to a circumference of the piston and a detection member that is at least one of assigned to the signal member and opposite to the signal member.

### CROSS-REFERENCE TO RELATED APPLICATIONS

The present application is:
a divisional of U.S. patent application Ser. No. 15/845,266, filed on Dec. 18, 2017, which:
   is a continuation of U.S. patent application Ser. No. 13/777,571, filed on Feb. 26, 2013, which:
      is a continuation of International Patent Application No. PCT/EP2011/064673, filed on Aug. 25, 2011, which:
         claims priority to German patent application 10 2010 040 045.9, filed on Aug. 31, 2010; and
         claims priority to German patent application 10 2010 035 492.9, filed on Aug. 26, 2010,
the entire disclosures of which are all hereby incorporated herein by reference in their entireties.

### STATEMENT REGARDING FEDERALLY SPONSORED RESEARCH OR DEVELOPMENT

Not Applicable

### FIELD OF THE INVENTION

The present invention lies in the field of brakes. The present disclosure relates to a master cylinder, in particular to a master cylinder for a hydraulic brake system or a hydraulic clutch system of handlebar steered vehicles and further in particular for a hydraulic brake system for bicycles and/or a hydraulic disk brake for bicycles.

### BACKGROUND OF THE INVENTION

Conventional brake disks of bicycle disk brakes have a central ring where six attachment openings are disposed. It is also known to attach brake disks of bicycle disk brakes by an adapter (a center lock adapter or central adapter) to the wheel hub of the bicycle. The known adapter has an internal gearing cooperating with the external gearing of a wheel hub. The exterior of the adapter also has projections that mesh with recesses of a particularly adapted brake disk. In order to assemble the brake disk by a center lock adapter, the adapter and the brake disk loosely connected therewith are disposed on the wheel hub and mounted on the wheel hub by a central screw so as to form a fixed connection between the wheel hub and the brake disk. The central screw additionally has an external thread that meshes with a corresponding internal thread of the wheel hub.

This known attachment of brake disks by a center lock adapter has the drawback that both the center lock adapter and the brake disk must be kept in the proper position when the central screw is mounted on the wheel hub. Another drawback is the use of brake disks that are particularly adapted to the center lock adapter and are not suited for the attachment on a conventional wheel hub that is not designed for the use of a center lock adapter.

Hydraulic bicycle disk brakes having a brake caliper, a brake line, a coupling link connected to the brake line and having an annular head, and a connecting link for connecting the coupling link with the brake caliper are known. In the known hydraulic bicycle disk brakes, the connecting link for connecting the coupling link with the brake caliper is a hollow screw that protrudes through the annular head of the coupling link and connects the brake line through the hollow interior of the hollow screw with the hydraulic channels that lead to the pressure chambers of the brake caliper. The hollow screws have the dual function of laterally attaching the coupling link to the brake caliper and producing a hydraulic connection.

These known hydraulic disk brakes have the drawback in that the hollow screw must have rather large dimensions to enable a safe and sufficiently stable connection between the coupling link and the brake caliper. This leads to a rather heavy weight.

In the case of known brake calipers of brake disks for bicycles, the hydraulic coupling bore is made in a direction parallel to the axis of the brake caliper cylinders where the brake pistons are disposed and act on brake pads to engage them with the brake band of a brake disk. In the case of the known hydraulic disk brakes, the brake line is disposed on the inner side of the firm frame part where the brake caliper is mounted to protect it from damage in the case of a fall. There is a danger that the brake line comes into engagement with the spokes of the wheel. In order to avoid this contact, the brake line of the known hydraulic disk brakes is mounted on the brake caliper through an angled coupling link to guide the brake line laterally outwards from the wheel. This leads to the drawback that the brake line can only be guided away from the brake caliper at a certain angle that is defined by the angle of the coupling link.

It is known for brake disks to use open brake systems, i.e., a compensation chamber is provided. Therefore, an external compensation container is usually provided in the case of a master cylinder for a hydraulic brake system for a two-wheeler, this container being connected to the cylinder chamber of the master cylinder. This, however, has a drawback in that the hydraulic brake system is rather heavy and requires a lot of space. In addition, the master cylinder has protruding parts. With particular regard to mountain biking and motorcycling, it is, however, desirable to use systems having the least possible weight and the fewest possible protruding parts.

Known brake calipers of hydraulic disk brakes have a disk chamber and a brake pad support that are disposed above the disk chamber. The known brake calipers have two side portions that laterally define the disk chamber. It also has a hydraulic coupling region that connects the two side portions with each other. Such brake calipers of hydraulic disk brakes have the drawback that the brake calipers must have a rather large and heavy design to achieve a sufficient rigidity.

Thus, a need exists to overcome the problems with the prior art systems, designs, and processes as discussed above.

### SUMMARY OF THE INVENTION

The invention provides a master mounting and hydraulic disk brake that overcomes the hereinafore-mentioned disadvantages of the heretofore-known devices and methods of this general type and that provide such features with easy mounting and/or having a high quality and a low weight and/or can be adjusted easily and reliably. Advantageous embodiments of the invention are defined in the dependent claims and/or the description and in particular in the following description.

According to an exemplary embodiment of the invention, a master cylinder is provided for a hydraulic brake system or clutch system, in particular of a handlebar steered vehicle, in particular a bicycle, comprising a housing containing a cylinder chamber, in which a piston slidable therein and a pressure chamber are disposed, and a compensation chamber that communicates with the pressure chamber through at least one compensation bore, a cover closing the housing and a counterpart for mounting the master cylinder on a handlebar tube, and comprising at least one connecting device for connecting the counterpart with the housing of the master cylinder, wherein the at least one connecting device has a first connecting portion for connecting the cover with the housing of the master cylinder and a second connecting portion for connecting the counterpart with the master cylinder and for the attachment of the master cylinder on a handlebar tube.

The advantage of such a configuration is that, due to the dual function of the connecting device, the cover can first be safely connected with the housing and then the counterpart can be connected with the housing of the master cylinder to attach the master cylinder to a handlebar tube disposed between the cover and the counterpart.

According to an exemplary embodiment of the invention, a collar can be provided between the first connecting portion and the second connecting portion of the at least one connecting device. The advantage of this configuration is that the cover can be pressed firmly against the housing when the at least one connecting device is mounted on the housing of the master cylinder. It is here advantageously also possible to seal the compensation chamber.

According to an exemplary embodiment of the invention, a stop can be provided at the cover where the collar abuts and/or is supported to prevent further penetration of the housing by the at least one connecting device when the cover is sufficiently firmly connected with the housing.

According to an exemplary embodiment of the invention, the connecting device and/or the collar can be configured such that, when the at least one connecting device is mounted on the housing, the collar forces the cover against the housing, thereby effecting a connection. A seal can be provided between the cover and the housing; this seal can be configured by the edge of a bellows that defines a compensation chamber provided in the housing. The bellows then has a dual function, namely, sealing the housing against the cover and defining the compensation chamber.

According to an exemplary embodiment of the invention, at least two connecting devices can be provided that are disposed along the periphery of the cover at equal distance.

According to an exemplary embodiment of the invention, a joint device can be provided opposite the at least one connecting device, the counterpart being formed so as to be pivoted on the joint and to be connectable through the opposite side with the master cylinder, the handlebar tube being clamped between the cover and the counterpart to attach the master cylinder to the handlebar tube.

According to an exemplary embodiment of the invention, the at least one connecting device or the connecting devices can comprise a stud bolt.

According to an exemplary embodiment of the invention, the at least one connecting device or the connecting devices can comprise a first threaded portion for attaching the stud bolt inside the housing. Alternatively or additionally, the connecting device can also be connected with the housing in another or additional way. For example, a press fit can be provided with which the connecting device is attached in the housing so as to mount the cover on the housing of the master cylinder. In this connection, the cover is forced against the housing by a collar.

According to an exemplary embodiment of the invention, the first connecting portion can have a plug-in device that can be screwed or press-fitted into a corresponding recess of the housing and/or a portion provided with a recess and adapted to be engageable by a corresponding portion of the housing to connect the first connecting portion with the housing so as to press the cover against the housing. The cover has an opening and/or a bore through which the first connecting portion is pushed when the cover is mounted on the housing of the master cylinder.

According to an exemplary embodiment of the invention, the first threaded portion can have a bolt-like and/or screw-like extension and/or portion that can mesh with a corresponding recess in the housing for attachment of the connecting device and the cover to the housing of the master cylinder and/or can be screwed or press-fitted therein.

Alternatively or additionally, the first threaded portion can have, according to an exemplary embodiment of the invention, a nut-like extension that can mesh with a corresponding support in the housing to attach the connecting device and the cover to the housing of the master cylinder and/or is screwed or pressed-fitted therein.

According to an exemplary embodiment of the invention, the second threaded portion can have a bolt-like and/or screw-like extension to attach a connector or connecting means serving for mounting the counterpart on the cover and/or with the housing on the handlebar tube, this extension serving for connecting a nut-like attachment device for attaching the counterpart.

Alternatively or additionally, the second threaded portion can have, according to an exemplary embodiment of the invention, a nut-like extension to attach a connector or connecting means for mounting the counterpart on the cover and/or with the housing on the handlebar; this extension serving for connecting a bolt-like and/or screw-like attachment or attachment means for mounting the counterpart.

According to an exemplary embodiment of the invention, the at least one connecting device can have a special tool engagement, wherein the at least one connecting device can be mounted on the housing by a special tool so as to connect the cover with the housing. The advantage of this configuration is that the user cannot open the master cylinder. This serves for ensuring a safe operation.

The invention is also based on providing a hydraulic disk brake that can be easily mounted and/or has a low weight and a high quality and/or can be adjusted simply and reliably. These features are provided by a disk brake as described herein. Individual solutions are defined in the independent claims. Advantageous exemplary embodiments of the invention are defined in the dependent claims and/or the description and in particular in the following description.

The invention is also based on providing a brake disk configuration that can easily be mounted on a wheel hub by a central screw and/or that allows the use of a brake disk that can also be mounted on a wheel hub without a center lock adapter.

According to an exemplary embodiment, a brake disk configuration for a hydraulic disk brake of a handlebar steered vehicle, in particular a bicycle and/or motorcycle, having an adapter (or center lock adapter or central adapter) and a brake disk is provided, wherein the adapter has an internal gearing for the anti-twist connection with a wheel hub of the handlebar steered vehicle and carriers for the anti-twist connection with the brake disk, the brake disk configuration having a connecting link for the undetachable connection of the brake disk with the adapter.

This configuration of the brake disk assembly has the advantage that the brake disk and the adapter form a unit where the brake disk can be undetachably connected with the adapter. In other words, the brake disk can be connected to the adapter by the connecting link in a direction that is at least substantially axial with respect to the wheel hub. It is preferred for the adapter to be here only loosely connected with the brake disk, i.e., the connection should suffice to ensure that the carriers of the adapter mesh with the brake disk. A fixed connection, i.e., a connection that does not enable an axial clearance between adapter and brake disk, is not necessary because it is usually achieved when the brake disk assembly is mounted on the wheel hub, which can be done by a central screw, for example, the central screw having an external thread that meshes with a corresponding internal thread of the wheel hub. When the central screw is tightened, the brake disk assembly is fixedly connected to the wheel hub. In this connection, a fixed axial connection is also achieved between the adapter and the brake disk. The loose connection between adapter and brake disk by the connecting link has the further advantage that, when a brake disk is exchanged, the connecting link can be easily loosened again, e.g., by loosening optionally existing locking and/or securing devices and removing the connecting link. The locking and/or securing devices can be hooks or locking hooks, for example, which form part of a circlip and extend through openings of the brake disks and engage behind a shoulder of the adapter, for example.

According to an exemplary embodiment of the invention, the carrier or carriers of the adapter can protrude in an axial direction, preferably along the thickness of the brake disk so that the brake disk and the carriers that mesh with the brake disk form a plain surface. The carriers of the adapter engage between openings of the brake disk that serve for attaching the brake disk with screws to conventional hubs.

According to an exemplary embodiment of the invention, the securing device of the connecting link can extend along the outer surface of the adapter, preferably at a distance from the axis that corresponds to the distance of the brake disk openings serving for attaching the brake disk to conventional hubs by screws. The configurations of the invention where the securing devices extend outside the adapter and engage externally at the adapter, e.g., against a shoulder, have the advantage that they have a particularly light weight because the adapter can have a small radial expansion. The carriers are, here, mounted externally on an adapter having the shape of a ring or a circular ring and extend from the adapter towards the brake disk, for example, by a length corresponding to the thickness of the brake disk.

According to an exemplary embodiment of the invention, the brake disk can be disposed between the adapter and the connecting link and/or the connecting link can have at least one connecting member that extends through an opening of the brake disk and can be disposed to mesh with the adapter.

The at least one connecting member can be, for example, a hook or a projection or arm provided with a hook and/or an undercut, which extends, in particular, in an axial direction with respect to the wheel hub. The connecting member has a dimension so that it can be pushed through the attachment openings of a conventional brake disk.

According to an exemplary embodiment of the invention, the connecting link can have at least one securing member for the anti-twist protection of a central screw by which the brake disk assembly can be attached to a wheel hub.

The connecting link can have a ring that is disposed parallel to the brake disk. Here, the at least one securing member is advantageously disposed on the exterior of the ring, i.e., the side of the ring that borders on the central screw when the brake disk assembly is assembled. The connecting member has several securing members that are advantageously distributed in a substantially uniform fashion over the ring. According to an exemplary embodiment of the invention, the ring can have regions where the securing members are disposed. The ring can be wider and/or have extensions in these regions. The connecting members can be disposed between these regions. In one exemplary embodiment according to the invention, six connecting members are provided, each meshing with an opening of a brake disk, which can be used for the conventional attachment of the brake disk without a central adapter. It is clear that fewer or more connecting members can be provided as well. For example, only one connecting member could be provided by which the brake disk can be undetachably mounted on the adapter. More preferred are configurations having at least two connecting members that are, for example, disposed opposite one another, i.e., shifted by 180 degrees in the circumferential direction. Configurations having, e.g., three connecting members, that are disposed at equal distance along the circumference, are also conceivable, i.e., shifted by 120 degrees in the circumferential direction.

The exemplary embodiments of the invention also provide a hydraulic disk brake that ensures low weight and safe and reliable functioning.

According to an exemplary embodiment of the invention, a hydraulic disk brake is provided for a handlebar steered vehicle, in particular for a bicycle and/or a motorcycle, which includes a brake caliper having a pressure chamber, a hydraulic coupling bore and at least one hydraulic channel that extends from a connecting portion of the hydraulic coupling bore to the at least one pressure chamber, a brake line, a coupling link connected to the brake line and having an annular head, and a connecting link disposed in the hydraulic coupling bore, the connecting link having a connecting region that is disposed in the head for the hydraulic connection of the brake line with the connecting link, the connecting link having an external gearing and/or at its exterior at least a groove and/or flattening which hydraulically connects the connecting region with the connecting portion.

This exemplary embodiment of the invention has the advantage that the connection between the coupling link and the brake caliper is more stable when the connecting link has equal dimensions and/or a connecting link having smaller dimensions can be used so as to obtain an equal stability and a lower weight of the hydraulic disk brake.

According to an exemplary embodiment of the invention, sealing members can be provided between the annular head of the coupling link and the connecting region of the connecting link, these members sealing in an axial direction of the connecting link and optionally in a radial direction of the connecting link.

Exemplary embodiments of the invention provide a hydraulic bicycle disk brake where the angle at which the brake line is guided away from the brake caliper can be easily adjusted within a certain region. Exemplary embodiments of the invention further provide a hydraulic bicycle disk brake where the coupling of the brake line to the brake caliper has an easy and reliable configuration.

According to an exemplary embodiment of the invention, there is provided a hydraulic disk brake for a handlebar steered vehicle, in particular a bicycle and/or motorcycle, comprising a brake caliper which has a pressure chamber, a hydraulic coupling bore and at least one hydraulic channel that extends from a connecting portion of the hydraulic coupling bore to the at least one pressure chamber, a brake line and a coupling link connected to the brake line and having an annular head, the hydraulic coupling bore extending in a direction that has an angle of approximately 5 to approximately 30 degrees relative to the direction of the at least one brake caliper cylinder, and/or the coupling link extending in a direction which has an angle of approximately 5 to approximately 30 degrees relative to a direction that is perpendicular to the direction of the axis of the at least one brake caliper cylinder.

According to an exemplary embodiment of the invention, there is provided an advantage in that the angle can be changed by turning the coupling link about the axis of the hydraulic coupling bore to guide the brake line away from the brake caliper at a desired angle.

According to an exemplary embodiment of the invention, the angle between the direction of the hydraulic coupling bore and the direction of the at least one brake caliper cylinder can be approximately 5 to approximately 20 degrees and, in particular, approximately 10 degrees, and/or the angle between the direction where the coupling link extends and the direction perpendicular to the direction of the axis of the at least one brake caliper cylinder can be approximately 5 to approximately 20 degrees and, in particular, approximately 10 degrees.

According to an exemplary embodiment of the invention, the hydraulic brake can have a connecting link according to the above-mentioned features. According to an exemplary embodiment of the invention, the connecting link can be accommodated in the hydraulic coupling bore. According to an exemplary embodiment of the invention, the annular head of the coupling link can surround the connecting link such that the coupling link is pivotable about the axis of the connecting link and/or the hydraulic coupling bore.

According to an exemplary embodiment of the invention, the coupling link can be straight. Due to the angular configuration of the hydraulic coupling bore, there is an advantage that the angle at which the hydraulic line extends away from the brake caliper can be changed by turning the hydraulic line about the connecting link.

According to exemplary embodiments of the invention, the master cylinder is lighter in weight and has the least possible number of protruding parts.

One advantage of the exemplary embodiments of the invention is that the compensation chamber can be integrated into the master cylinder and a sufficient volume can be created simultaneously with no protruding parts being required for the compensation chamber.

According to some exemplary embodiments of the invention, there is provided a master cylinder for a hydraulic brake system and/or clutch system having a cylinder chamber where a pressure chamber is disposed, and a compensation chamber that is connected with the pressure chamber through at least one compensation bore, wherein at least one further compensation bore is provided that connects the pressure chamber with the compensation chamber and/or the compensation chamber is provided between the cylindrical wall of the cylinder chamber and the housing wall of the master cylinder housing which accommodates the cylinder chamber, and/or wherein at least one ridge and/or rib is provided between the cylindrical wall defining the cylinder chamber and a wall defining the compensation chamber (which can be, in particular, a wall of the housing of the master cylinder), this ridge or rib connecting the compensation chamber wall with the cylinder chamber wall, and/or wherein the compensation chamber at least partially surrounds the cylindrical wall of the cylinder chamber, and/or wherein the compensation chamber is divided into at least two sectors that are laterally disposed from the cylindrical wall defining the cylinder chamber.

These exemplary embodiments of the invention have the advantage that the master cylinder including the compensation chamber can be built in an extremely compact fashion, a sufficient volume for the compensation chamber being simultaneously provided. In addition, the stability is sufficient. For example, the compensation chamber can enclose at least approximately 90° of the cylinder chamber, more particularly at least approximately 120°, even more particularly at least approximately 150°, more particularly at least approximately 180°, more particularly at least approximately 210°, more particularly at least approximately 240°, more particularly at least approximately 270°, more particularly at least approximately 300°, more particularly at least approximately 330° and, in particular, the entire circumference of the cylinder chamber.

The term “cylindrical wall defining the cylinder chamber” is to be comprehended in connection with the present industrial property right such that it refers to the interior of the wall defining the cylinder chamber, along which a piston glides upon actuation of the master cylinder and that is usually sealed through a gasket.

The exterior of the cylindrical wall defining the cylinder chamber can, of course, also have an uneven shape. The outer wall is, advantageously, also substantially cylindrical to provide the largest possible volume for the compensation chamber.

There is a connection between the compensation chamber and the pressure chamber through the compensation bores as long as the gasket of the piston has not traveled over the compensation bores. The openings, leading to the cylinder chamber, of the compensation bores are advantageously disposed at least approximately at the same location based on the moving direction of the piston so that the openings of the compensation bores are traveled over at the same time.

According to an exemplary embodiment of the invention, the compensation chamber can be divided into three sectors by at least two ridges. For example, the sectors can be uniformly distributed around the cylindrical wall of the cylinder chamber so that each has a sector of approximately 120°, for example. It is clear that some degrees have to be deducted from the 120°, which depend on the thickness of the ridge defining the sector.

According to an exemplary embodiment of the invention, the compensation chamber can be divided into four sectors each having approximately 90° and being divided at least in the lower region by four ridges disposed uniformly around the circumference of the cylinder chamber.

According to an exemplary embodiment of the invention, the individual sectors of the compensation chamber can be connected with one another above the ridges dividing the compensation chamber into sectors. The advantage of this configuration is that the compensation chamber sectors can be sealed by a single bellows.

According to an exemplary embodiment of the invention, a hydraulic disk brake is provided having a brake caliper with a high stability and rigidity and being rather light.

According to an exemplary embodiment of the invention, there is also provided a hydraulic disk brake with a brake caliper having a disk chamber and a brake pad support disposed above the disk chamber, the brake caliper having two side portions that laterally define the disk chamber, and a hydraulic coupling region that connects the two side portions with each other, the brake caliper having a connecting portion for connecting the two side portions, the brake pad support being disposed between the hydraulic coupling portion and the connecting portion.

According to an exemplary embodiment of the invention, the connecting portion can be positioned in off-center fashion based on the cylinder chamber.

According to an exemplary embodiment of the invention, the connecting portion can enclose with the hydraulic coupling portion an angle of less than approximately 120°, particularly of less than approximately 100°, more particularly less than approximately 90°, more particularly less than approximately 80°, and, in particular, of about approximately 70°.

According to an exemplary embodiment of the invention, the hydraulic coupling portion and the connecting portion can enclose an angle of more than approximately 50°, particularly more than approximately 60° and, in particular, of approximately 70°.

According to an exemplary embodiment of the invention, the hydraulic coupling portion and/or the connecting portion can be disposed substantially along a tangent of the cylinder chamber and/or substantially along a tangent of the brake caliper housing in the region of the cylinder chamber.

According to an exemplary embodiment of the invention, the hydraulic coupling can also be disposed at the brake caliper at another location outside the hydraulic coupling region shown in the exemplary embodiments. What is decisive is that the brake caliper has two stiffening regions and/or brackets that connect the two brake caliper sides defining the disk course. The brackets can be advantageously disposed corresponding to the stiffening brackets of suspension forks.

According to an exemplary embodiment of the invention, a brake caliper is thus also provided having two side wall portions defining a disk chamber, a cylinder chamber accommodating a piston being formed in at least one side wall portion, the two side wall portions being connected with each other, the brake caliper having first and second stiffening regions and/or first and second brackets and/or first and second arch portions that connect the side wall portions of the brake caliper with one another.

According to an exemplary embodiment of the invention, the stiffening regions and/or arches and/or brackets can be disposed to extend in planes that run at an angle of approximately 120 to approximately 30° with respect to one another, particularly at an angle between approximately 100 and approximately 40°, more particularly at an angle of approximately 80 to approximately 50° and, in particular, at an angle of approximately 60° with respect to one another.

According to an exemplary embodiment of the invention, the reinforcing regions and/or brackets and/or arches can be disposed on planes that extend outside the central axis of the piston bore of the cylinder. The planes where the reinforcing regions, brackets and/or arches are disposed extend substantially approximately tangentially with respect to the piston bore of the cylinder of the brake caliper.

According to an exemplary embodiment of the invention, the connecting regions and/or arches and/or brackets can be disposed at an angle of approximately 15 to approximately 60°, particularly at an angle of approximately 20 to approximately 50°, more particularly at an angle of approximately 25 to approximately 40° and, in particular, at an angle of approximately 30° relative to the angle bisector of the planes where the reinforcing regions and/or brackets and/or arches are disposed. It is beneficial for both angles to be approximately equal.

According to an exemplary embodiment of the invention, the height of the reinforcing regions, brackets and/or arches can be greater than the width.

The height of the reinforcing regions and/or brackets and/or arches is the dimension of the reinforcing regions and/or brackets and/or arches in a direction extending radially outwardly with respect to the brake disk. The thickness or width of the reinforcing regions and/or stiffening regions and/or brackets and/or arches is to be comprehended in connection with the present application to be the dimension of the reinforcing regions and/or stiffening regions and/or brackets and/or arches in the circumferential direction of the brake disk.

According to an exemplary embodiment of the invention, the reinforcing regions and/or stiffening regions and/or brackets and/or arches can have a dimension as regards the height that is approximately at least 1.2 times, particularly at least 1.5 times, more particularly at least 1.75 times and, in particular, approximately two times the thickness of the connecting regions and/or reinforcing regions and/or brackets and/or arches.

According to an exemplary embodiment of the invention, the height of the reinforcing regions and/or stiffening regions and/or brackets and/or arches can be at least 5 times, particularly at most 4 times, more particularly at most 3 times and, in particular, about two times the thickness of the connecting regions and/or stiffening regions and/or brackets and/or arches.

Exemplary embodiments of the invention provide a master cylinder where the pressure point and the handlebar width can easily be adjusted and have a cost-effective construction.

According to an exemplary embodiment of the invention, a master cylinder for a hydraulic brake or clutch is provided having a brake lever and a cylinder housing where a piston is slidably disposed that is connected with the brake lever through a spindle, the master cylinder having an adjusting device for adjusting the handlebar width and the pressure point, the adjusting device having an actuating member by which it is possible to adjust the handlebar width in a first position and the pressure point in a second position.

The master cylinder according to an exemplary embodiment of the invention has an advantage that, due to the dual function of the actuating member, the adjusting device can be very compact and have small dimensions. This serves for saving weight and cost. In addition, the adjustment is very simple.

According to an exemplary embodiment of the invention, the actuating member can be biased with a spring device into the first position for adjusting the handlebar width and/or into the second position for adjusting the pressure point. According to an exemplary embodiment of the invention, the adjusting device can be configured such that the actuating member can be engaged with a locking sleeve in the adjustment, which surrounds a second member that can be meshed with the actuating member in the other position. This embodiment of the invention has the advantage of being extremely compact and having the thus associated low weight.

According to an exemplary embodiment of the invention, the actuating member can be a turning knob that, in the first position, is connected with a first adjusting link for rotation therewith and, in a second position, is connected with a second adjusting link for rotation therewith.

The actuating member can be moved according to an exemplary embodiment of the invention from the first position into the second position by pressing the actuating member.

According to an exemplary embodiment of the invention, the actuating member can be turned for adjustment in the first position and/or in the second position to turn the adjusting link connected with the actuating member for rotation therewith.

Exemplary embodiments of the invention also provide a master cylinder where the handlebar width can be easily adjusted and with a cost-effective construction.

According to an exemplary embodiment of the invention there is provided a master cylinder for a hydraulic brake or clutch having a lever, a thrust member and a cylinder housing where a piston is slidably disposed, the piston being connected with the thrust member through a spindle, the master cylinder having an adjusting device for adjusting the handlebar width by changing the angle between the lever and the thrust member, the adjusting device being supported on the thrust member, the adjusting device having a spacer that is supported on the thrust member and that is secured against rotation by the thrust member. This configuration has an advantage of being compact and having a low weight and low costs.

According to an exemplary embodiment of the invention, the spacer can have an extension that is disposed between a thrust member region that has a substantially fork-like design and/or between two extensions of the thrust member so as to secure the spacer against rotation.

According to an exemplary embodiment of the invention, the spacer can have a point and/or flange that extends laterally from the spacer and is supported on the thrust member. In this regard, “lateral” means perpendicular to the plane where the lever and the thrust member are pivoted or turned when the master cylinder is actuated.

Exemplary embodiments of the invention also provide a master cylinder where the pressure point can be easily adjusted with a cost-effective construction.

According to an exemplary embodiment of the invention, there is provided a master cylinder for a hydraulic brake or clutch having a lever and a cylinder housing where a piston is slidably disposed, the piston being connected with the lever through a spindle, the master cylinder having a pressure point adjusting device, the pressure point adjusting device being disposed and configured such that the limit stop of the piston can be adjusted at the housing.

According to an exemplary embodiment of the invention, the adjusting device can have a stop member connected with the housing for rotation therewith, which is slidably disposed in axial fashion with respect to the housing, and/or the adjusting device can have an adjusting link that is pivotable relative to the cylinder housing, and its movement is limited in an axial direction based on the cylinder.

According to an exemplary embodiment of the invention, the adjusting element can be limited in the axial direction by a pin that is supported in the housing.

Exemplary embodiments of the invention also provide a master cylinder where the piston position can readily be detected and has a cost-effective configuration.

According to an exemplary embodiment of the invention, a master cylinder for a hydraulic brake or clutch is provided having a lever and a cylinder housing where a piston is slidably disposed, the piston being secured against rotation in the cylinder housing and the piston position detection device having a signal member asymmetrically disposed along the periphery of the piston and a detection member assigned to the signal member and/or opposite thereto.

According to an exemplary embodiment of the invention, the signal member can be a bar magnet and the detection member can be a Hall sensor. This configuration has an advantage in that the piston position detection device can be simple and cost-effective. It is, in particular, not necessary to provide a configuration symmetric with respect to the periphery of the piston and the housing to only obtain a proper detection of the position in an axial direction of the piston even though the piston is turned in the housing.

According to an exemplary embodiment of the invention, the master cylinders can be used for hydraulic brakes or clutches and/or be a part thereof. In particular, the master cylinders according to the invention can be parts of hydraulic disk brakes or caliper brakes of bicycles or other handlebar steered vehicles and/or can be used for such a purpose.

According to an exemplary embodiment of the invention, the material of the housing of the master cylinder and/or the brake caliper may comprise die-cast material and/or fiber-reinforced plastics, in particular, carbon fiber-reinforced plastics, e.g., a thermoset material and/or a thermoplastic material.

Exemplary embodiments of the invention also provide a hydraulic disk brake where brake pads have a cost-effective construction and can rapidly and easily be assembled and/or exchanged.

According to exemplary embodiments of the invention, a hydraulic disk brake having a brake caliper is provided having a disk chamber and a brake pad support disposed above the disk chamber, the brake pad support having a distance from the central plane of the disk chamber that is greater than or equal to half the thickness of the brake pad. This embodiment has an advantage in that the brake pad is inserted from below into the duct of the brake caliper and can be laterally slid on the brake pad support where it is, then, advantageously secured by the brake disk. According to an exemplary embodiment, the two brake pads can be slid in opposite directions.

According to an exemplary embodiment of the invention, the brake caliper can have a duct for supporting the brake pad, wherein the brake pad support can be formed on opposite duct sides in the peripheral direction of the disk chamber (based on the running direction of the wheel and/or the brake disk).

According to an exemplary embodiment of the invention, the brake caliper can have a duct for supporting the brake pad, wherein the brake pad support can be configured in the peripheral direction of the disk chamber (based on the running direction of the wheel and/or the brake disk) centrally relative to the duct.

According to an exemplary embodiment of the invention, the brake pad support can have guides that mesh with corresponding supports of the brake pads and can be partially surrounded by the latter. This configuration has an advantage in that the brake pads can be hung approximately like coat-hangers on the rail or curtains in a curtain rail without a bolt having to be removed and having to be pushed through a closed support of the brake pads, as known in the prior art.

According to an exemplary embodiment of the invention, a brake pad is provided for a hydraulic brake having a brake caliper that has a disk chamber, the brake pad having extensions for surrounding the brake pad support of the brake caliper, the extensions being disposed and constructed such that the brake pad can be slid from a position in the central plane of the disk chamber of the brake caliper to the side onto the brake pad support.

According to an exemplary embodiment of the invention, the extensions can be disposed in pairs laterally and above the region where the friction pad of the brake pad is provided.

According to an exemplary embodiment of the invention, the extensions can be disposed above the region where the friction pad is provided, the extensions forming a bracket pair for mounting the friction pad on the brake pad support.

Although the invention is illustrated and described herein as embodied in a master mounting and hydraulic disk brake, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is an exploded view of an exemplary embodiment of a brake disk assembly having a central screw;

FIG. 2 is a cross-sectional side view of the brake disk assembly of FIG. 1 in the assembled condition, the wheel hub having been omitted for the sake of clarity;

FIG. 3 is an exploded, cross-sectional side view of the brake disk assembly of FIG. 1;

FIG. 4 is an exploded, cross-sectional view, corresponding to FIG. 3, of an alternative embodiment of the brake disk assembly;

FIG. 5 is a cross-sectional view of an exemplary embodiment of a brake caliper with a brake line of a hydraulic disk brake;

FIG. 6 is a fragmentary, perspective view of part of the hydraulic disk brake of FIG. 5 showing the connecting link and the coupling link;

FIG. 7 is a fragmentary, perspective view of the brake caliper of FIG. 5 with further details of the connecting link of FIG. 5;

FIG. 8 is an exterior elevational view of the brake caliper and brake line of FIG. 5;

FIG. 9 is a side elevational view of the brake caliper and brake line of the hydraulic disk brake of FIG. 5;

FIG. 10 is a cross-sectional view corresponding to FIG. 5 of an exemplary embodiment of a disk brake;

FIG. 11 is an interior top elevational view of a housing of an exemplary embodiment of a master cylinder without a cover and without a bellows defining the compensation chamber from above;

FIG. 12 is a side elevational view of the housing of the master cylinder of FIG. 11 towards the cylinder without a piston and without parts closing the cylinder chamber;

FIG. 13 is an elevational and partially hidden view of the master cylinder of FIG. 11, part of the housing being shown towards the compensation container without cover and without bellows defining the compensation chamber;

FIG. 14 is a perspective view of the bellows defining the compensation chamber of the master cylinder of FIG. 11;

FIG. 15 is a side elevational view of the bellows of FIG. 14;

FIG. 16 is a bottom plan and partially hidden view of the bellows from a direction of the compensation chamber;

FIG. 17 is a side elevational view of the bellows of FIG. 14;

FIG. 18 is a cross-sectional view of an exemplary embodiment of a master cylinder, of a hydraulic disk brake;

FIG. 19 is a fragmentary, enlarged cross-sectional view of the master cylinder of FIG. 18 in a region of the circle XIX;

FIG. 20 is an exploded cross-sectional view of an exemplary embodiment of a master cylinder for a hydraulic disk brake;

FIG. 21A is a fragmentary, diagrammatic detail of the master cylinder of FIG. 20 in a region of the circle XXI of FIG. 20;

FIG. 21B is a diagrammatic view of the adjusting member and the thrust member of the master cylinder of FIG. 20 from a direction of the piston, the other parts being omitted for the sake of clarity;

FIG. 22 is a cross-sectional view of an exemplary embodiment of a master cylinder of a hydraulic disk brake;

FIG. 23 is a fragmentary, cross-sectional view of the master cylinder of FIG. 22 in a region of circle XXIII of FIG. 22.

FIG. 24 is a perspective view of the master cylinder of FIG. 22.

FIG. 25 is a fragmentary, perspective view of the master cylinder of FIG. 22 in a region of the circle XXV of FIG. 24;

FIG. 26 is a side elevational view of the master cylinder of FIG. 22.

FIG. 27 is a bottom plan view of a spacer of the master cylinder of FIG. 22;

FIG. 28 is a side elevational view of the spacer of FIG. 27;

FIG. 29 is a side elevational view of the spacer of FIG. 27;

FIG. 30 is a perspective view of the operating device of the pressure point adjusting device of the master cylinder of FIG. 22;

FIG. 31 is a side elevational view of the actuating device of FIG. 30;

FIG. 32 is a perspective view from below the operating device of FIG. 30;

FIG. 33 is a side elevational view of the actuating device of FIG. 30;

FIG. 34 is a cross-sectional view of an exemplary embodiment of a master cylinder including a sensor device for detecting a position of the piston along line XXXIV-XXXIV of FIG. 41;

FIG. 35 is a cross-sectional view of an exemplary embodiment of a master cylinder;

FIG. 36 is a side elevational view of the brake caliper of FIG. 9;

FIG. 37 is a perspective cross-sectional view of the brake caliper of FIG. 36, the section extending through the disk chamber;

FIG. 38 is a cross-sectional view of the brake caliper of FIG. 36, the cutting plane being located in a center of a disk chamber;

FIG. 39 is a side elevational view of the brake caliper of FIG. 36 from the direction opposite with respect to FIG. 36;

FIG. 40 is a cross-sectional view of the brake caliper of FIG. 38 with auxiliary lines serving for illustrating a geometry of components reinforcing the brake caliper;

FIG. 41 is a cross-sectional view of the master cylinder of FIG. 34 along line XLI-XLI of FIG. 34;

FIG. 42 is a perspective view of the master cylinder of FIG. 34;

FIG. 43 is a side elevational view of an exemplary embodiment of a brake pad;

FIG. 44 is a cross-sectional view of an exemplary embodiment of a brake caliper in the plane of the brake disk with a brake pad according to FIG. 43;

FIG. 45 is a fragmentary, perspective view of the brake caliper of FIG. 44 showing an attachment of the brake pads of FIG. 43 to the brake caliper of FIG. 44;

FIG. 46 is a top plan view of the brake caliper of FIG. 44 without brake pads in the direction of the hub (with mounted brake caliper);

FIG. 47 is a top plan view of the brake caliper of FIG. 44 without brake pads in a direction opposed to the one of FIG. 46;

FIG. 48 is a side elevational view of the brake caliper of FIG. 44 with inserted brake pads according to FIG. 43;

FIG. 49 is a bottom plan view of the brake caliper of FIG. 44 without brake pads (based on FIG. 48);

FIG. 50 is a top plan view of the brake caliper of FIG. 44 without brake pads (based on FIG. 48);

FIG. 51 is a side elevational view of an exemplary embodiment of a brake pad;

FIG. 52 is a cross-sectional view of an exemplary embodiment of a brake caliper in the plane of the brake disk including a brake pad according to FIG. 51;

FIG. 53 is a fragmentary perspective view of the brake caliper of FIG. 52 showing an attachment of the brake pads of FIG. 51 to the brake caliper of FIG. 52;

FIG. 54 is a top plan view of the brake caliper of FIG. 52 with inserted brake pads according to FIG. 51 in the direction of the hub (with mounted brake caliper);

FIG. 55 is a top plan view of the brake caliper of FIG. 52 with inserted brake pads according to FIG. 51 in a direction opposite to that of FIG. 54;

FIG. 56 is a side elevational view of the brake caliper of FIG. 52 with inserted brake pads according to FIG. 51;

FIG. 57 is a bottom plan view of the brake caliper of FIG. 44 with inserted brake pads according to FIG. 51 (based on FIG. 56); and

FIG. 58 is a top plan view of the brake caliper of FIG. 52 with inserted brake pads according to FIG. 51 (based on FIG. 56).

Reference numbers used in the description follow the exemplary embodiments.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

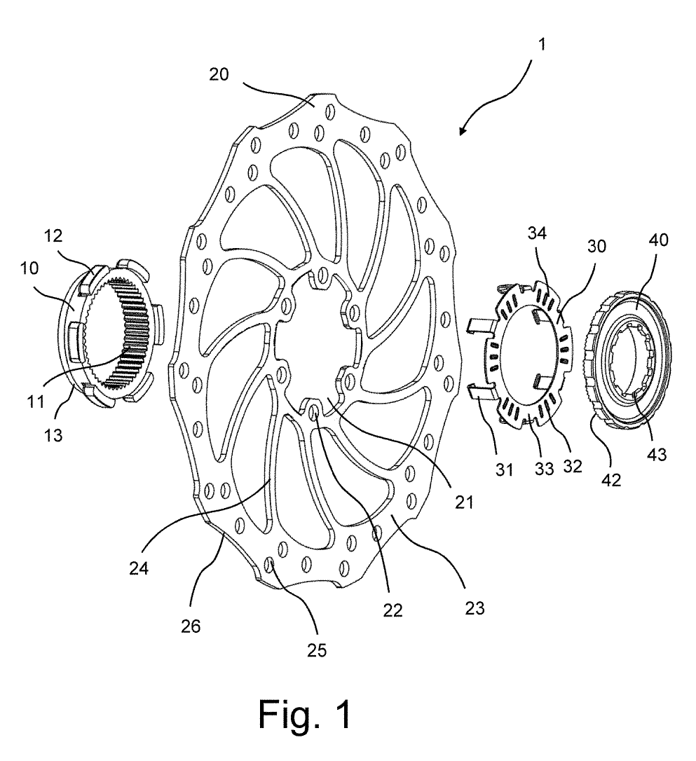

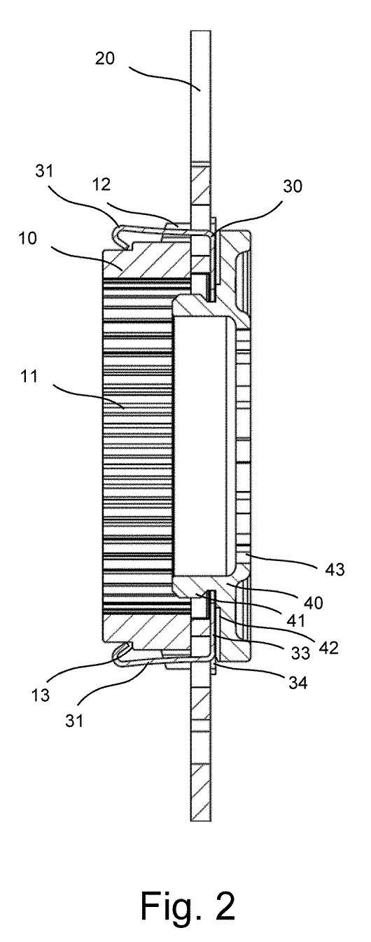

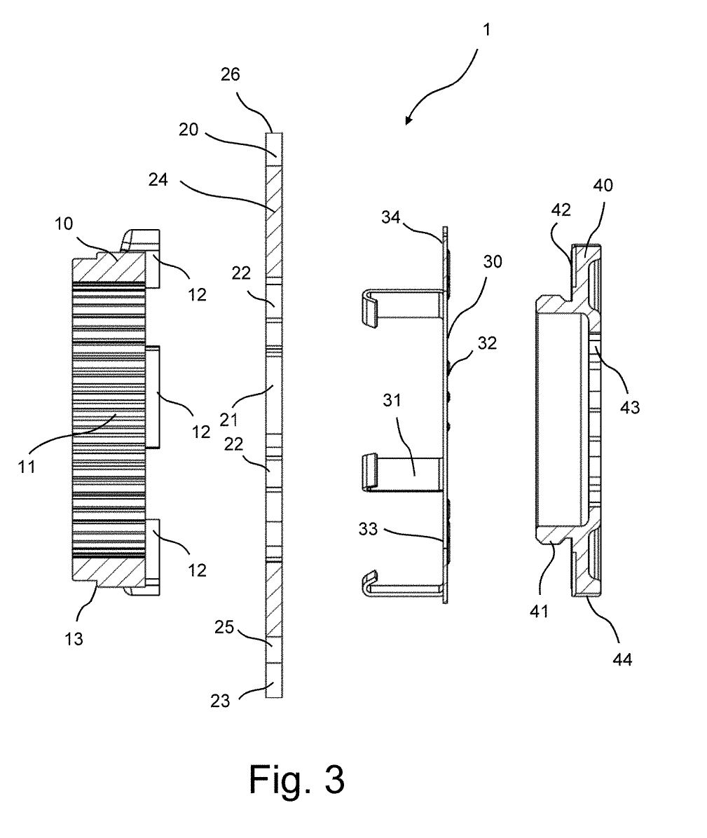

Described now are exemplary embodiments of the present invention. Referring now to the figures of the drawings in detail and first, particularly to FIGS. 1 to 3, there is shown a first exemplary embodiment of a brake disk assembly 1 according to a design of the invention.

The brake disk assembly 1 has an adapter 10, a brake disk 20, and a connecting link 30. The adapter 10 has an internal gearing 11 that can be disposed on corresponding external gearing of a wheel hub for the anti-twist connection between adapter 10 and wheel hub. Such wheel hubs are known to a person skilled in the art and are not shown in the figures.

The adapter 10 has carriers 12 that protrude in an axial direction. The brake disk 20 has recesses 21 that are configured to accommodate the carriers 12 of the adapter 10 therein to produce an anti-twist connection between the adapter 10 and the brake disk 20.

The carriers 12 protrude in an axial direction by a length that corresponds to the thickness of the brake disk 20. The brake disk 20 then abuts against the adapter 10 between the carriers 12 by areas where the openings 22 are provided and it forms, together with the carriers 12 of the adapter 10, a planar support surface for the connecting link 30.

The brake disk 20 has a brake band 23 that, by several struts 24, is connected with an inner ring where six openings 22 are disposed to serve for receiving attachment screws when the brake disk 20 is to be attached to a wheel hub without a central adapter (center lock adapter). The six recesses 21 are disposed between the regions having the openings 22. Openings 25 are provided in the brake band 23. The effect of the openings 25 in the brake band 23 are known to the person skilled in the art.

Furthermore, the brake band 23 has an outer contour 26 that is not circular. The effect of the non-circular outer contour of the brake band is known to the person skilled in the art.

The connecting link 30 has a ring 33 that extends substantially parallel to the plane of the brake disk 20. Six connecting members 31 extend from the ring 33 in a substantially axial direction. The connecting members 31 are made of a resilient material and have a hook at their end. The connecting members 31 are distributed along the periphery of the ring 33 in accordance with the openings 22 of the brake disk 20 and are disposed to be pushed through the openings 22. The adapter 10 has a shoulder 13. The connecting members 31 are made and disposed so that the connecting link 30 can be pushed by the connecting members 31 through the openings 22 in the brake disk 20 and the connecting members 31 can be locked behind the shoulder 13 of the adapter when the adapter 10 is disposed in the recesses 21 of the brake disk 20 by its carriers 12. Such a configuration yields a brake disk assembly 1 according to the invention where the brake disk 20 is undetachably disposed at the adapter 10. The connecting link 30 creates a loose connection that suffices to connect the brake disk 20 with the adapter 10. A fixed connection between the adapter 10 and the brake disk 20 is achieved in the assembly of the brake disk assembly 1 at the wheel hub (not shown) when the central screw 40 is connected with the wheel hub. When the brake disk is exchanged, the connecting member or members 31 can easily be removed from the adapter 10 by slightly pressing open the hook-like connecting members 31 to loosen the connecting members 31 from the shoulder 13 of the adapter 10 behind which they engage. The connecting link 30 can then be removed to loosen the connection between the adapter 10 and the brake disk 20.

At the ring 33, the connecting link 30 has six extensions 34 that extend radially outwards from the ring 33 in the regions corresponding to the recesses 21 in the brake disk 20. In these areas where the ring 33 has extensions 34, securing members 32 are provided to avoid unintended loosening of the central screw 40. The central screw 40 has an external thread 41 that cooperates with a non-illustrated wheel hub internal thread to fix the brake disk assembly 1 to the wheel hub. The central screw 40 also has a spur gearing 42 that, when the brake disk assembly 1 is mounted on the wheel hub by the central screw 40, is disposed at the securing members 32 such that the securing members 32 engage the spur gearing 42 and prevent a twist of the tightened central screw 40 in a sufficiently reliable fashion.

The inner contour of the central screw 40 has a tool engagement 43 and the outer contour thereof has a tool engagement 44. The tool for tightening and loosening the central screw 40 can mesh with the tool engagement 43 and/or the tool engagement 44. Correspondingly, the person skilled in the art is aware that the central screw can also only have the tool engagement 43 on the inner contour or the tool engagement 44 on the outer contour.

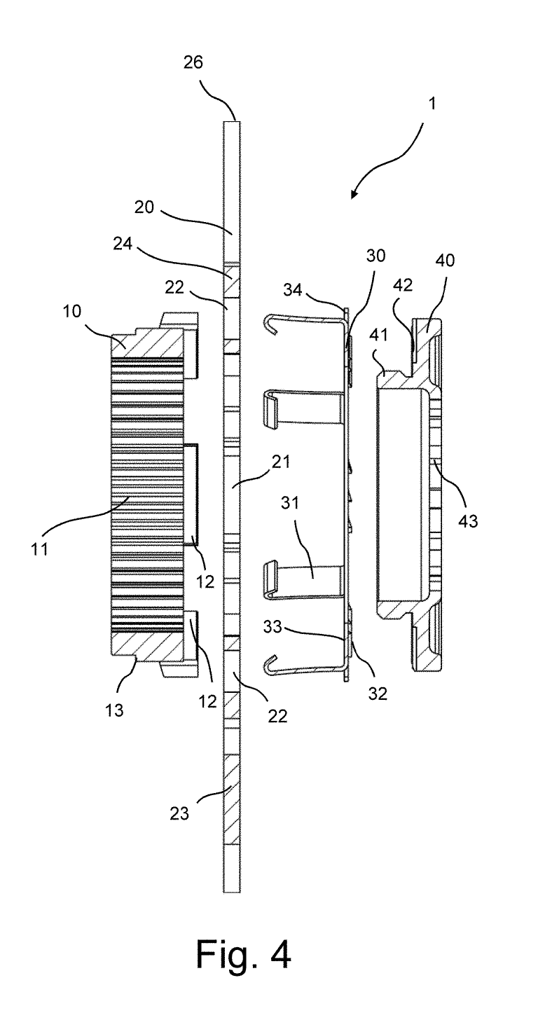

FIG. 4 shows an alternative configuration of a brake disk assembly according to the invention. The same components are described with equal reference numbers. Reference is made below to the description of the assembly according to FIGS. 1 to 3 and only the differences between the assembly of FIG. 4 and the assembly according to FIGS. 1 to 3 are described.

In the brake disk assembly 1 according to FIG. 4, the connecting link 30 has at its ring 33 securing members 32 having a hook-like contour. This contour leads to a ratchet effect when the central screw is tightened, i.e., the force required for tightening the central screw 40 is lower than the force required for loosening because a kind of a barbed hook effect results when the central screws 40 are loosened. The central screw shown in FIG. 4 has no tool engagement 44 on the outer contour of the central screws 40.

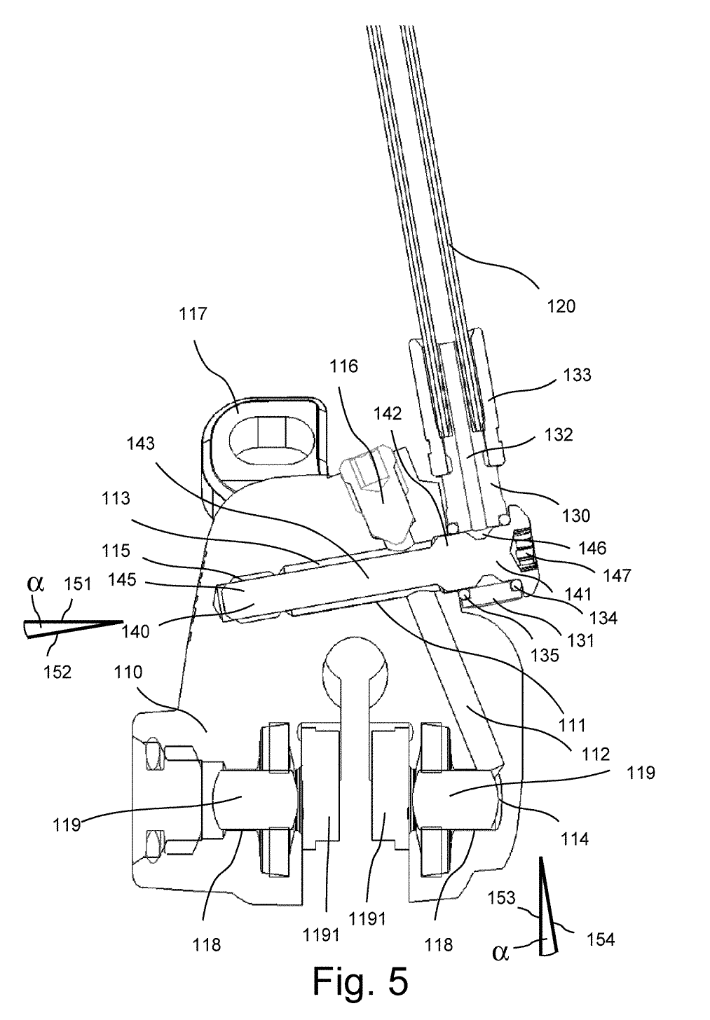

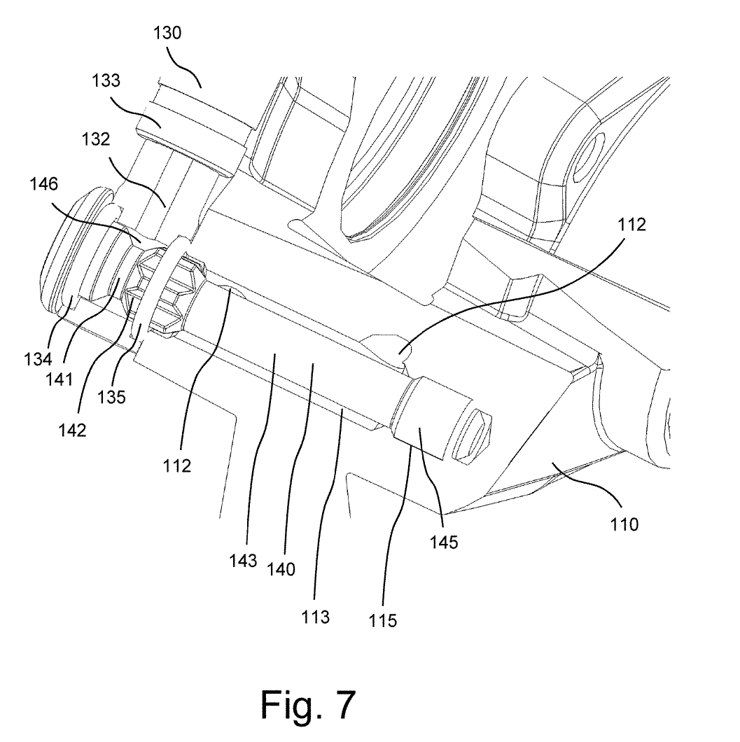

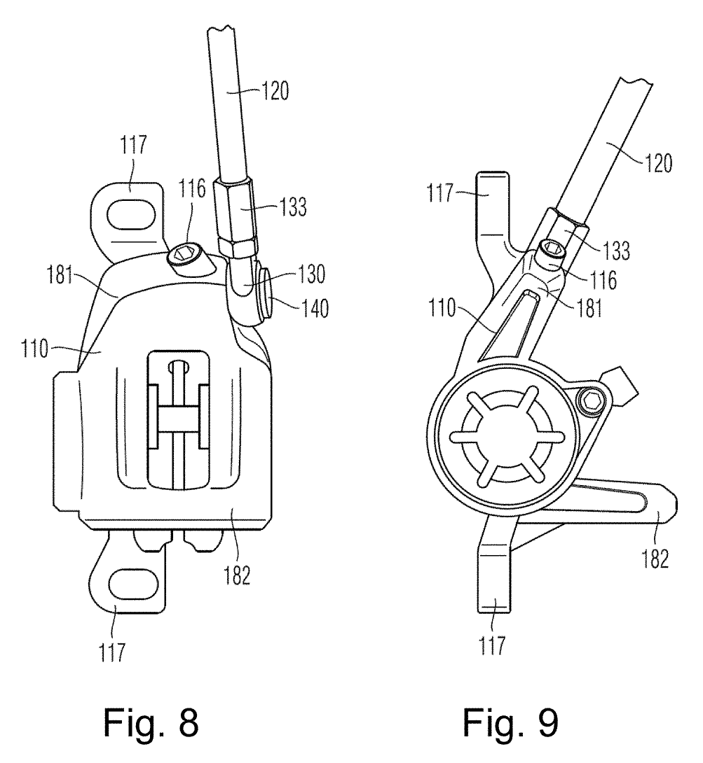

FIGS. 5 to 9 show a brake caliper 110 of a hydraulic brake disk according to the present invention.

The hydraulic brake disk has a brake caliper 110 where a hydraulic coupling bore 111 is provided. The hydraulic coupling bore 111 extends at an angle of about 10° inclination relative to the axis of the cylinder bores of the brake caliper cylinder. The axis of the cylinder bores substantially corresponds to the wheel axis. The cylinder bores accommodate pistons 119 that abut brake pads 1191 against a brake disk (not shown) to decelerate the wheel (not shown).

A hydraulic channel 112 extends from the hydraulic coupling bore 111 to a pressure chamber 114. In the configuration shown, the brake caliper 110 has two pressure chambers 114 each connected with a hydraulic channel 112 that is connected with the connecting portion 113 of the hydraulic coupling bore 111. The cutting plane illustrated in FIG. 5 only shows one hydraulic channel 112. The other hydraulic channel 112 can extend in another cutting plane or is not shown for the sake of clarity. The end of the hydraulic coupling bore 111 has a threaded portion 115 into which a connecting link 140 is screwed by an external threaded portion 145.

A closure 116 is disposed in a filling opening not defined in more detail. The brake caliper 110 can be mounted on a fixed frame part of the two-wheeler or bicycle or motorcycle by its coupling portions 117 in a way known to the person skilled in the art.

The hydraulic disk brake has a brake line 120 at which a coupling link 130 is disposed. The coupling link 130 has an annular head 131. The coupling link 130 has an inner connecting channel 132. The line 120 is pressed by a sleeve 133 onto the coupling link 130 in a way known to the person skilled in the art. The annular head 131 accommodates gaskets 134, 135, which take the form of O-ring gaskets as shown.

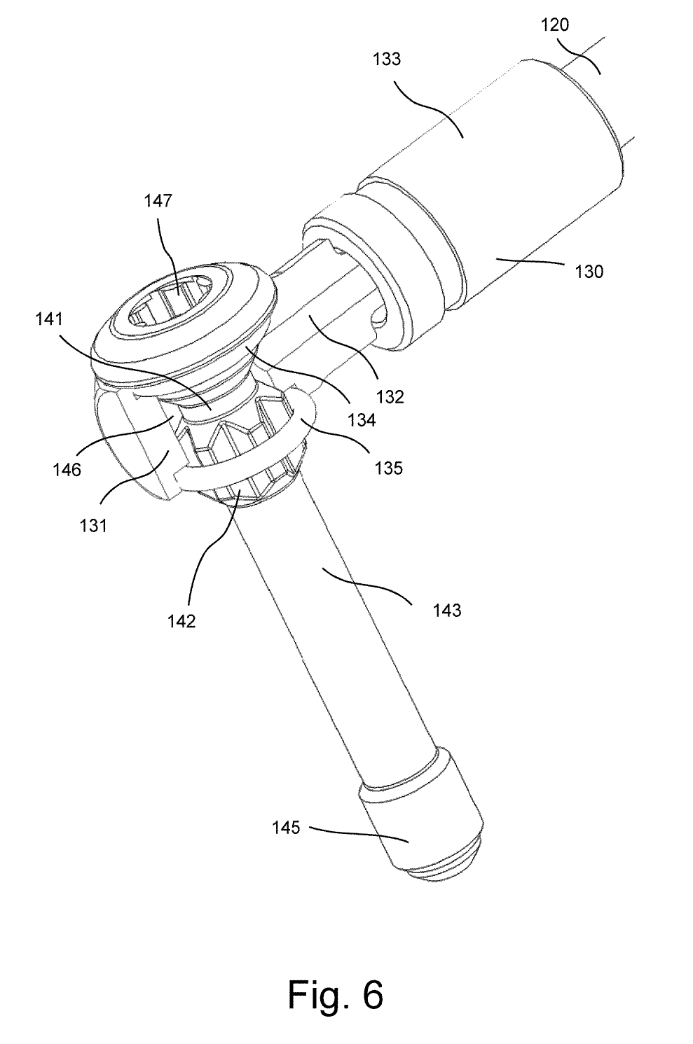

The connecting link 140 is disposed in the annular head 131 of the coupling link 130. The connecting link 140 has a connecting region 141 into which the connecting channel 132 opens. The connecting link 140 has a circumferential groove 146 in the connecting region 141. The connecting region 141 is sealed by gaskets 134, 135 with respect to the coupling link 130. The connecting link 140 has a connecting portion 143 that has a smaller outer diameter than the connecting portion 113 of the hydraulic coupling bore 111. The connecting link 140 also has a threaded portion 145 including an external thread, which is screwed into the threaded portion 115 of the coupling bore 111. To hydraulically connect the connecting region 141 with the connection portion 113 of the coupling bore 110, the connecting link 140 has an external gearing 142 (e.g., see FIG. 6). To obtain a hydraulic seal, the gasket 135 seals between the coupling link 130 and the brake caliper housing in an axial direction of the connecting link 140. Due to this seal, it is not necessary for a seal to be established between the coupling link 130 and the connecting link 140. On account of the external gearing 142 this is not possible in this section anyway. The gasket 135 can be configured to establish a seal in the radial direction and/or axial direction of the connecting link 140. In order to achieve a good seal, a seal is desirable in an axial direction of the connecting link 140.

The connecting link 140 also has a tool engagement portion 147 configured in a known manner.

The exemplary embodiment according to the invention has an advantage in that the connecting link 140 has no inner channel, such as in the case of a hollow screw. Thus, the connecting link can be made smaller and/or have a greater stability.

According to an alternative, the connecting link 140 can have at least one groove that hydraulically connects the connecting region 141 with the connecting portion 113. This groove can be provided additionally or alternatively with respect to the external gearing 142.

FIG. 6 illustrates a detail where only the coupling link 130 and the connecting link 140 are shown. FIG. 6 depicts the hydraulic connection between the coupling link 130 and the connecting link 140 and the associated seal. The hydraulic line 120 is shown at the upper edge by way of diagram. The hydraulic line 120 is hydraulically connected through the hydraulic channel 132 with the connecting region 141 that is connected with the connecting portion 143 through the external gearing 142. The seal is established through the gaskets 134, 135, which seal in both radial and axial directions of the connecting link 140.

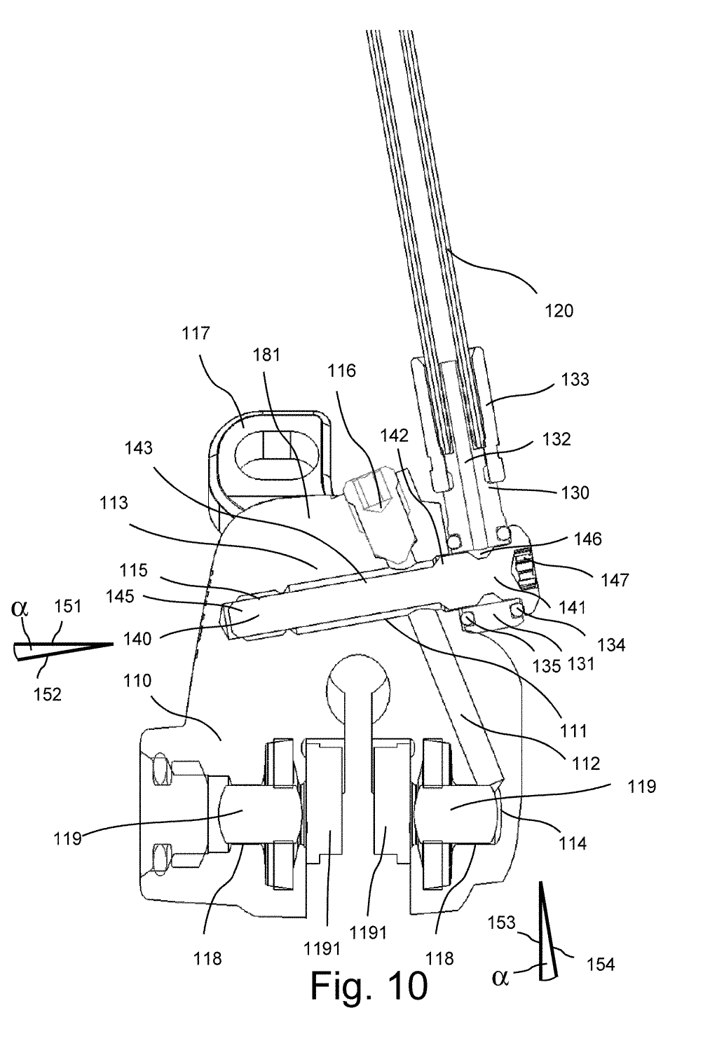

FIG. 10 shows an alternative embodiment of a disk brake according to the invention. The same components are described with equal reference numbers as described in the exemplary embodiment shown in FIGS. 5 to 9. Reference is made below to the description of the embodiment according to FIGS. 5 to 9 and only the differences between the embodiment of FIG. 10 and the embodiment according to FIGS. 5 to 9 are described.

The embodiment according to FIG. 10 differs from the embodiments in FIGS. 5 to 9 in that, in the annular head 131 of the coupling link 130, grooves are provided in which the gaskets 134 and/or 135 are disposed. Due to the configuration of the gaskets 134 and 135, in one groove each there is only a seal in an axial direction of the connecting link 140, i.e., the gasket 134 seals between the annular head 131 of the coupling link 130 and the head of the connecting link 140 and the gasket 135 seals between the annular head 131 of the coupling link 130 and the housing of the brake caliper 110.

The hydraulic coupling bore 111 extends in the brake caliper in a direction 152 at an angle α relative to direction 151 of the axis of the brake caliper cylinder 118. The connecting link 140 is disposed in the hydraulic coupling bore 111 and is also inclined by angle α with respect to direction 151 of the axis of the brake caliper cylinder 118. In the connecting region 141, the connecting link 140 has a circumferential groove and/or recess that is in hydraulic communication with the hydraulic channel 132 in the coupling link 130. In the illustrated embodiment, the connecting link 140 has an external gearing 142 that is disposed between the connecting region 141 and the hydraulic transfer region 143. Alternatively and/or additionally, the connecting link 140 can have a flattening provided in the region where the external gearing is provided in the exemplary embodiment shown in FIGS. 5 to 9.

The coupling link 130 has a straight configuration, i.e., the annular head 131 changes without an angle into the region where the line 120 is attached to the sleeve 133. The coupling link 130 is disposed through an annular head 131 at the connecting region 141 of the connecting link, i.e., it is rotatable about the axis of the connecting link 140 that extends along direction 152. Due to the inclined configuration of the hydraulic coupling bore 111, the coupling link 130 is also inclined by angle α, which in FIGS. 5 and 9 is shown as an angle between the direction 154 where coupling link 130 extends and direction 153 that extends perpendicularly to the direction 151 of the axis of the brake caliper cylinder 118.

Angle α is about 10° in the embodiments shown in the figures. According to exemplary embodiments, the angle α can also have a greater or smaller value, i.e., in a range from approximately 5 to approximately 20°, for example, and, where appropriate, also in a range from approximately 5 to approximately 30°.

Due to the inclined configuration of the hydraulic coupling bore 111 in the brake caliper 110, the angle where the brake line 120 leads away from the brake caliper can be slightly changed by turning the coupling link 130 about the connecting link 140. The maximum angle where the brake line 120 is markedly guided to the outside is obtained when the brake line is precisely turned upwards. The further the brake line 120 is turned into the horizontal, the smaller becomes the angle at which the brake line is guided laterally to the outside. When the brake line 120 is guided parallel to the bottom, the brake line 120 is not guided to the outside but extends along the axis of the two-wheeler. As a result of the inclined configuration of the hydraulic coupling bore 111, there is also a simple and safe configuration of the coupling link 130, which can be straight because the angle for guiding away the brake line 120 is created by the inclined configuration of the hydraulic coupling bore 111.

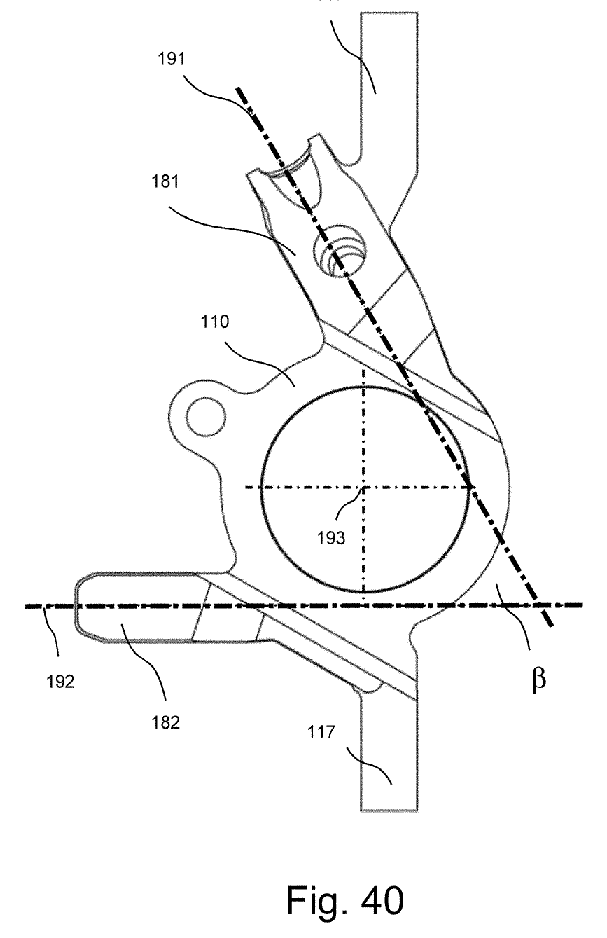

FIG. 40 shows an exemplary embodiment geometry of the brake caliper 110. The brake caliper 110 has two side walls where bores are formed to receive a piston. The central line of the piston bores is designated with reference number 123. Auxiliary lines are shown to mark the central point. The brake caliper 110 is mounted by two flanges 117 on a fixed frame part (not shown) of a two-wheeled vehicle. The two side walls of the brake caliper are connected with each other through brackets 181 and 182. A brake pad support is provided between brackets 181 and 182. The stiffening regions or brackets 181 and 182 are positioned with respect to each other at an angle β that is approximately 60° in the embodiment shown. An angle in this range is exemplary as other angles are conceivable. The amount of the angle also depends on the distance of the planes where the brackets 181, 182 are disposed. The planes where the brackets are disposed are designated by reference number 191 and 192, respectively. The smaller the distance of the planes 191, 192 from the central line 193, the larger is angle β. According to the exemplary embodiment, the distance of the planes 191 and 192 from the central line 193 is approximately the radius of the cylinder bore.

As shown in FIG. 38, the hydraulic coupling bore 111 is also provided in bracket 181. When the hydraulic coupling bore is not provided in bracket 181, the bracket 181 can have a smaller thickness. For example, the bracket 181 can then have the same thickness as the bracket 182. In this embodiment, like bracket 182, the bracket 181 then has a larger distance from the central line 193, in other words that the material is removed on the inner side of bracket 181.

According to an exemplary embodiment of the invention, the height of the bracket 181 is greater than its thickness. In the embodiment shown, the height of the bracket 181 is approximately two times the thickness of the bracket 181. This ratio is even greater with bracket 182.

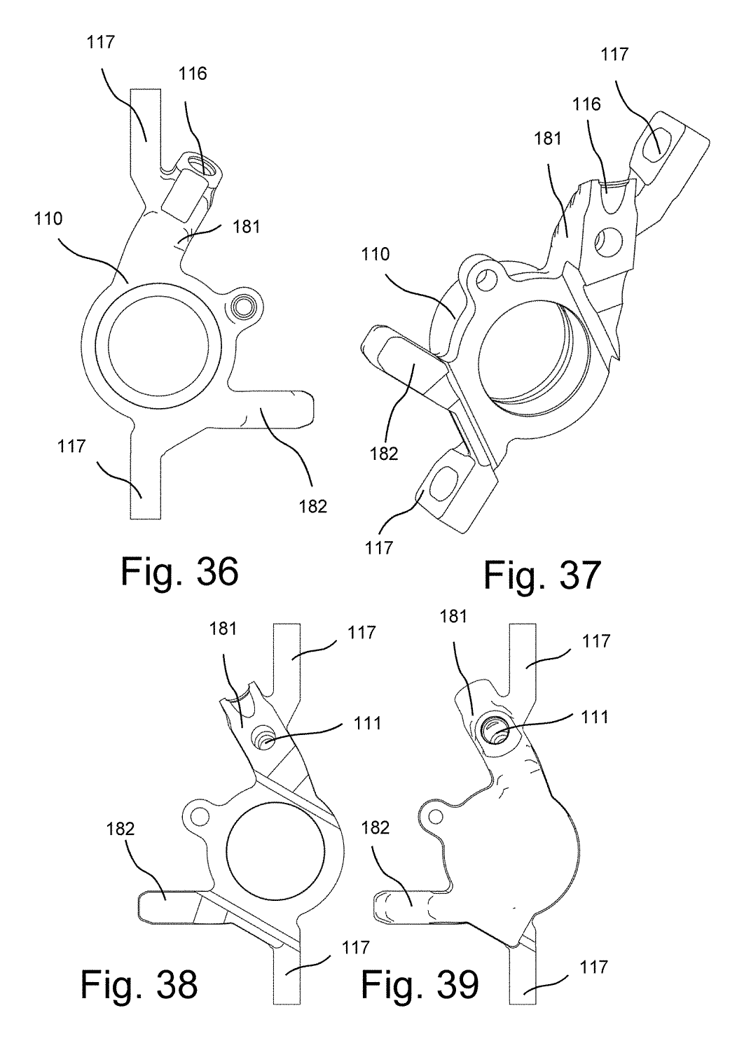

For further details, reference is made to FIGS. 35 to 38 and the exemplary embodiments according to FIGS. 5 to 9 and/or 10.

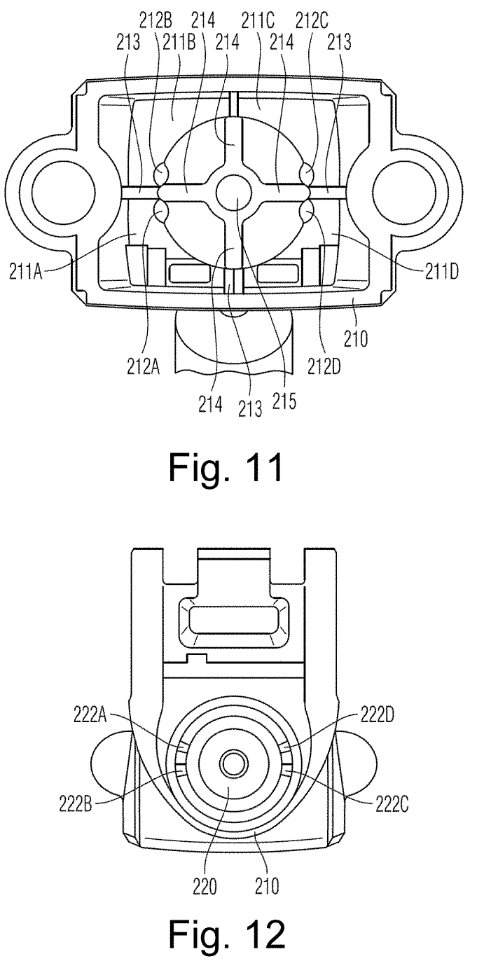

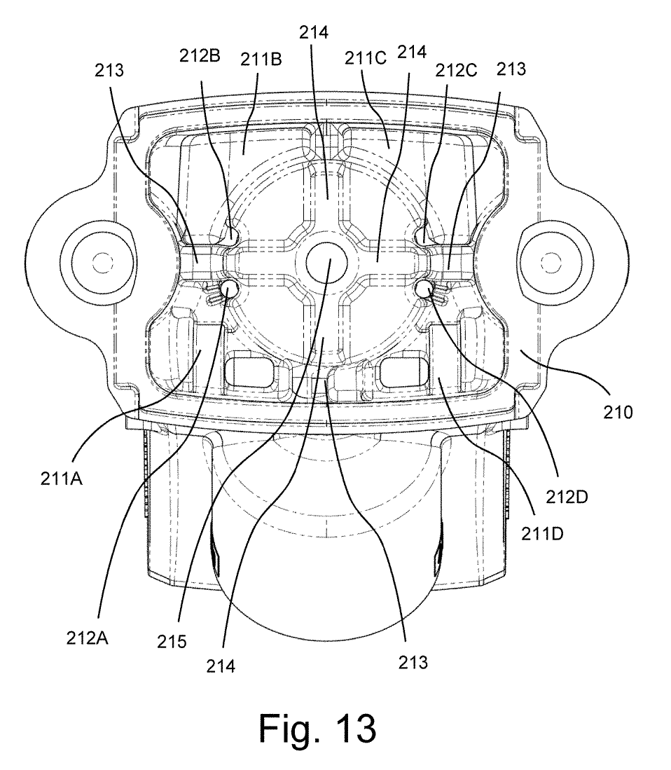

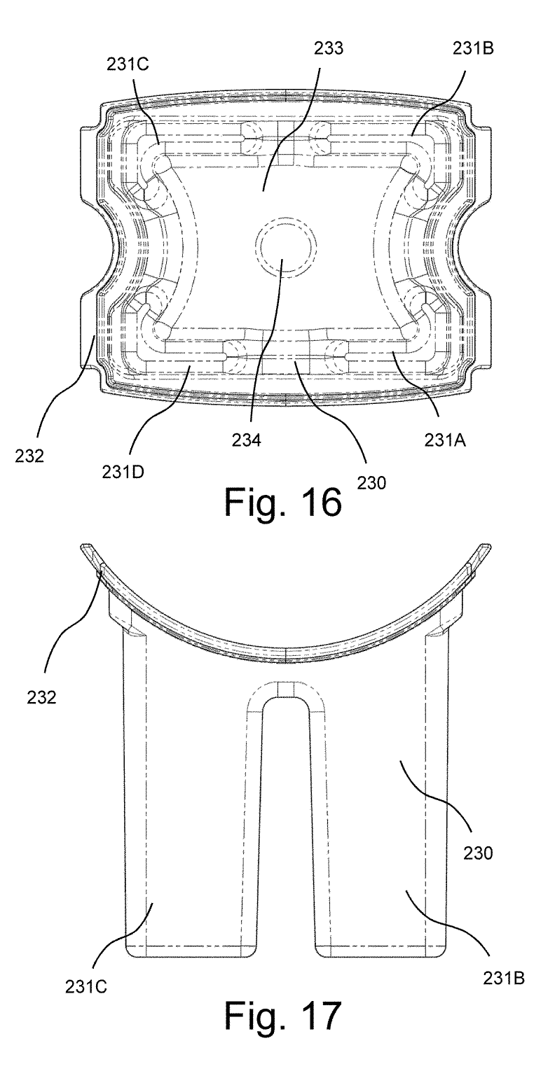

FIGS. 11 to 17 show details of a master cylinder according to the invention, the focus being on the development of the compensation chamber 211A, 211B, 211C, 211D and bellows 230. The compensation chamber is divided into four portions 211A, 211B, 211C and 211D disposed about the cylinder chamber 220 in the housing 210 of the master cylinder. The cylinder chamber 220 is disposed centrally in the housing 210 of the master cylinder and a piston (not shown) is slidably disposed therein. The cylinder wall of the cylinder chamber 220 has four openings 222A, 222, 222C, 222D, which are connected with a compensation chamber portion 211A, 211B, 211C, 211D with the compensation bores 212A, 212B, 212C, 212D each to create a connection between the pressure chamber and the compensation chamber 211 as long as the piston (not shown) has not traveled over the openings 222A to 222D by its gasket (not shown). The cylindrical wall defining the cylinder chamber 220 is connected through ridges 213 with the wall of the housing of the master cylinder. This leads to a greater stiffness. Instead of the ridges 213, it is also possible to provide ribs or bridges or other stiffening members. When these members do not extend to the bottom of the compensation chamber (the lower plane shown in FIG. 11 or in FIG. 13), only one compensation bore can be provided because a connection for exchange of the hydraulic medium is provided at the bottom of the compensation chamber.

Ribs 214 are formed on the front face closing the cylinder chamber 220 and have a substantially crosswise configuration. These ribs 214 serve the purpose of reinforcement and can be omitted, where desired.

A recess 215 is provided in the middle of the cross formed by the ribs 214. A bulge 234 of the bellows 230 can mesh with the recess 215.

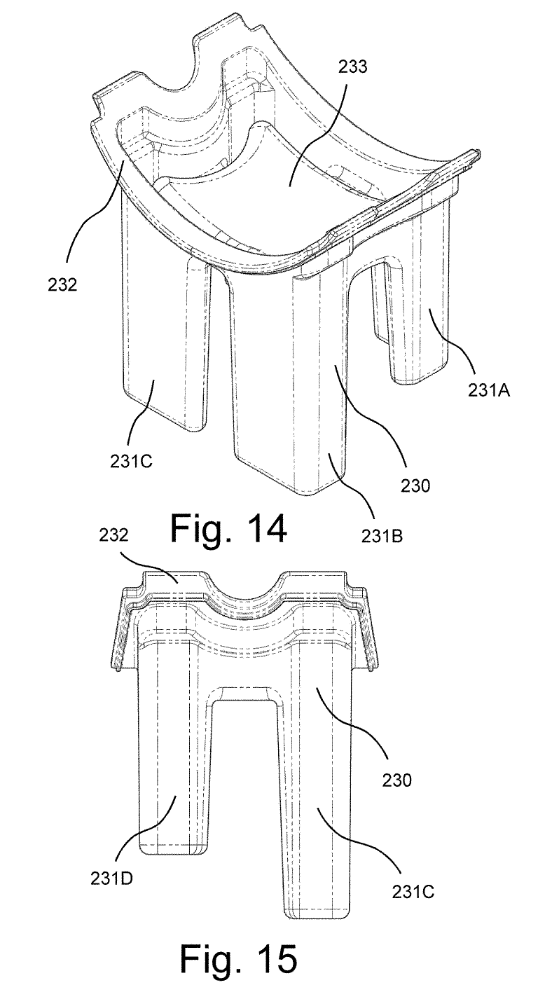

The bellows 230 is shown in FIGS. 14 to 17. The bellows 230 has four extensions 231A, 231B, 231C, 231D that extend from area 233 downwards. The extensions 231A, 231B, 231C, 231D substantially comprise L-shape columns shaped to utilize the volume available around the cylinder chamber in a most optimum way. The bellows 230 has a circumferential edge 232 shaped in accordance with the edge of the housing of the master cylinder to be sealable with a cover opposite the housing to create a compensation chamber sealed to the outside and whose volume can be adapted to the hydraulic fluid amount present in the compensation chamber by deformation of the bellows.

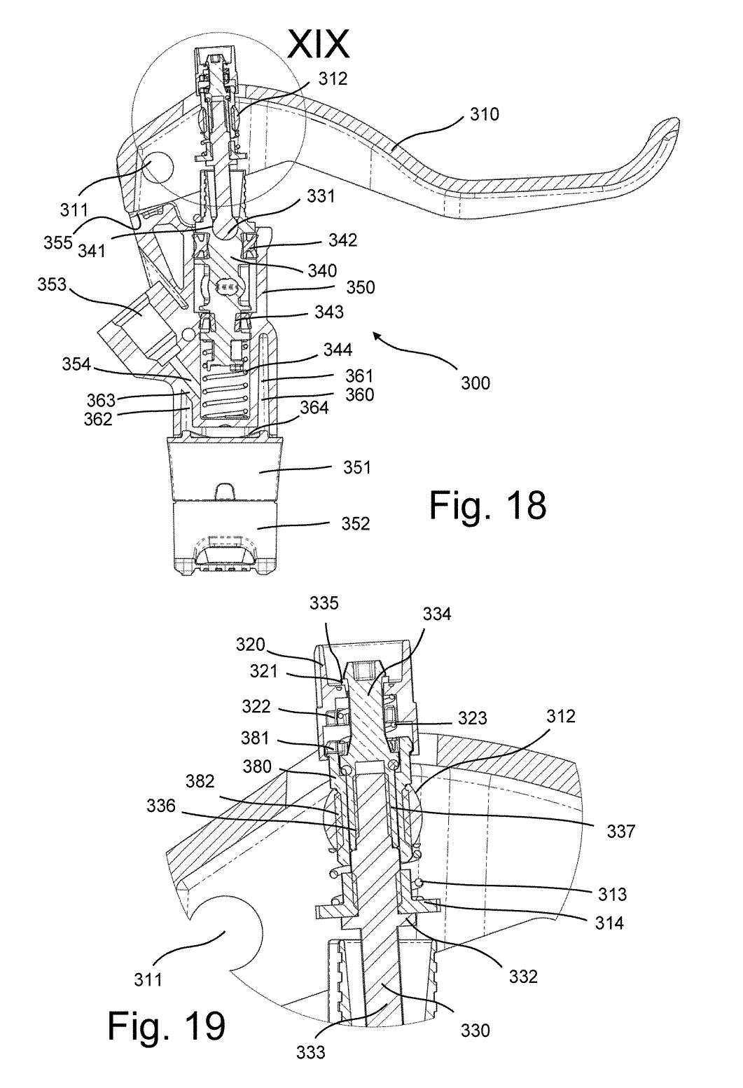

FIGS. 18 and 19 show an exemplary embodiment of a master cylinder 300 of a hydraulic disk brake. The master cylinder 300 has a brake lever 310 rotatably supported on the housing of the master cylinder with a bolt 311. The master cylinder has a housing 350 that can be mounted on the handlebar tube through two semi-shells 351, 352 receiving the handlebar tubes. The handlebar tube as such is not shown in this exemplary embodiment. A piston 340 is slidably disposed in a known manner in the cylinder chamber of the master cylinder. The piston 340 is sealed by gaskets 342, 343 with respect to the cylinder wall.

The adjusting device has a knob 320 disposed on a spindle 330. The spindle 330 is connected with the piston 340. The spindle 330 has a head 331 fixedly locked in a support 341 of piston 340 such that an axial movement of the spindle 331 is not possible while the spindle 330 can be tilted with respect to the piston 340, which is necessary when the master cylinder is actuated. The spindle 330 has a collar 332. The spindle 330 is made of two parts and has a part 333 closer to the piston (lower part) and an outer part connected with the actuation knob 320 of the adjusting device (upper part) 334. The upper spindle part 334 is connected with the lower spindle part 333 through a threaded connection, i.e., the length of the spindle 330 becomes larger or smaller when the upper part 334 is turned against the lower part 333. The upper part 334 of the spindle has an external gearing 335 that meshes with an internal gearing 321 in the position of the knob 320, which is shown in FIG. 19. When the knob 320 is turned, the outer part 334 of the spindle 330 is rotated due to the engagement of the gearing 321 with the gearing 335. Thus, the upper part 334 is rotated with its internal thread 336 on the external thread 337 of the inner part 333 of the spindle 330. This leads to a change in the length of the spindle and, thus, the position of the piston 340 in the cylinder chamber. As a result, it is possible to change the pressure point and/or the idle travel, i.e., the path of the piston 340 that the piston 340 has to travel in the cylinder so that the gasket 343 moves over the compensation bore.

The master cylinder also has a locking sleeve 380 that is screwed by an external thread 382 in a bolt 312 received in a support. The locking sleeve 380 has an end wall gearing 381. The knob 320 of the adjusting device has a gearing 322 that, by pressing the knob 320 in the direction of the piston, can be engaged with the front end gearing 381 of the locking sleeve 380. By pressing the knob 320, it is thus possible by turning the knob 320 due to the engagement of the gearing 322 with the gearing 381 to rotate the locking sleeve 380 in the bolt 312 so that the handlebar width can be adjusted. The knob 320 accommodates a spring 323 that biases the knob 320 to the outside. As a result of this bias, it is ensured that the adjusting device is always in a position for adjusting the idle travel and/or the pressure point when the knob 320 is not pressed actively.

To adjust the handlebar width, the knob 320 must actively be pressed in the direction of the piston 340, and the spring 322 ensures that, after the handlebar width adjustment, the knob 320 returns into its original position where the idle travel and/or pressure point can be adjusted.

The master cylinder 300 has a spring 313 that biases the lever 310 in its rest position, i.e., about the fulcrum of the bolt 311 against the stop 355 of the housing. As a result, the support for the bolt 312 is outwardly biased. The spring 313 is supported on the outer part 334 of the spindle 330 and, on the opposite side, on a nut 314 secured against torsion.

In the housing 350 of the master cylinder, a compensation chamber 360 is provided and has several sections. The section 361 on the side opposite the filling opening 353 is shown. On the side opposite this section 361, the transition region 362 is shown between two compensation chamber sections (not shown) that are separated by a ridge 363 through which the channel 354 extends. A bellows 364 defining the compensation chamber 360 is disposed between the housing cover 351 and the housing 350. According to an exemplary embodiment, the bellows 364 can be formed as shown in FIGS. 13 to 17, for example. In the embodiment of FIGS. 18 and 19, the compensation chamber 360 has three compensation chamber portions, namely the compensation chamber portion 361 opposite the filling opening 353 and is separated from two further portions through two ridges disposed substantially symmetrically to the filling opening 353. The compensation chambers extend over about 120° each. Alternatively, the compensation chambers can also extend over different angle areas around the cylinder chamber. For example, the compensation chamber opposite the filling opening 353 could extend over 180° and the compensation chambers at the sides of the filling opening or the channel 354 could extend over approximately 90° each, the angular range being reduced by the size of the ridges separating the compensation chamber portions.

The master cylinder 300 is mounted through the cover 351 and the counterpart 352 on the handlebar (not shown). To facilitate the assembly, the counterpart 352 can have an angular range of less than about 180°, which includes the handlebar tube, and the cover 351 can include an angular range that comprises more than about 180°. The advantage of this configuration is that the master cylinder 300 can be forced onto the handlebar tube to enable a simple and easy assembly.

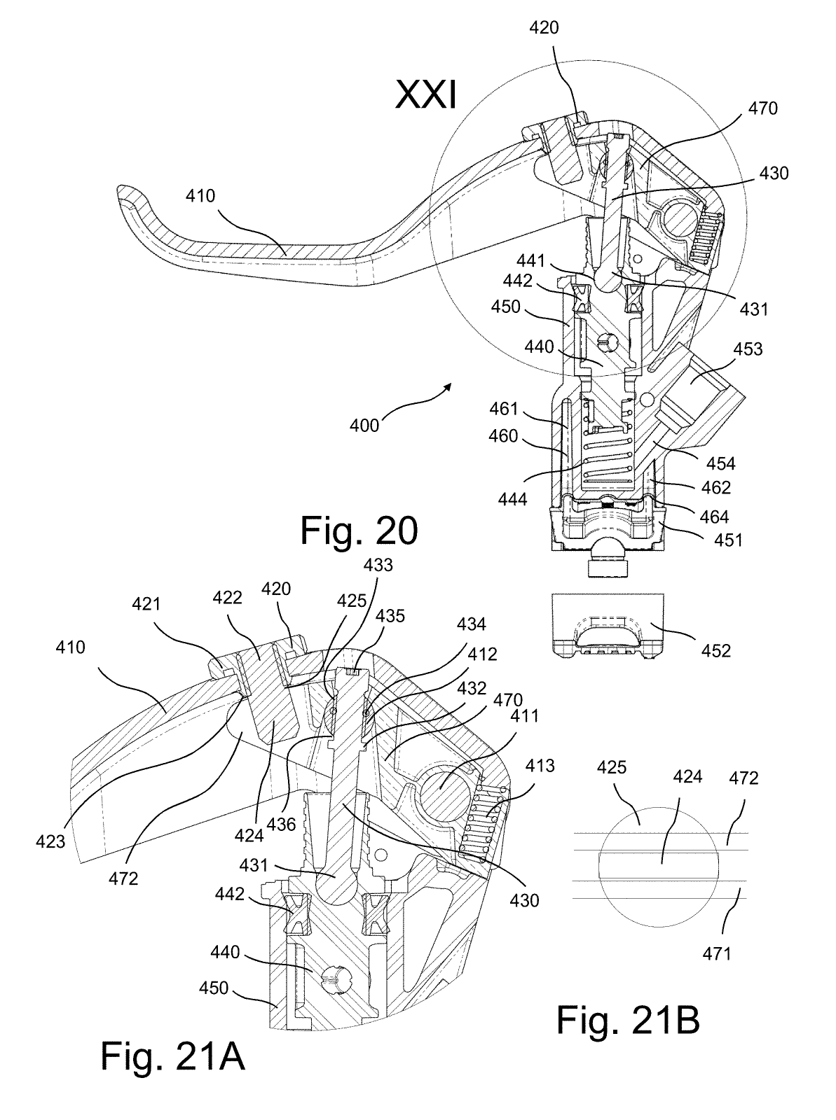

FIGS. 20 to 21B show a further embodiment of a master cylinder of a hydraulic brake or clutch. The same components have corresponding reference numbers that are increased by 100 with respect to the embodiment of FIGS. 18 to 19. Only the differences are described below and, as for the rest, reference is made to the description of the other exemplary embodiments and in particular to the description of the exemplary embodiment of FIGS. 18 and 19. The exemplary embodiment of FIGS. 20 to 21B differs from the exemplary embodiment in FIGS. 18 and 19 by a different adjusting device having a separate actuating link for the adjustment of the handlebar width and the adjustment of the pressure point. The lever 410 is rotatably supported about a bolt 411. For this purpose, a thrust member 470 is provided, which is rotatably supported about the bolt 411. The lever 410 is supported on the thrust member 470 through an adjusting device for the handlebar width. A spring 413 is provided between the thrust member 470 and the lever 410, and it biases the lever 410 in the adjusting device against the thrust member 470. The adjusting device for the handlebar width 420 has a turning knob 421 that is rotatably supported about its axis in the lever 410. It is kept in position by a collar 423. A spacer 422 is disposed in the turning knob 421. In the region of the turning knob 421, the spacer 422 has an external thread that is connected with an internal thread of the turning knob 421. In a region of the adjusting knob and/or spacer 422, the thrust member 470 has two spaced apart extensions 471, 472 between which an extension 424 of the spacer 422 extends. A flange 425 is provided between the threaded portion and the extension 424 and has a substantially circular shape in the embodiment shown. The adjusting device is supported on the thrust member 470 by the flange 425. Because the turning knob 421 is fixedly connected with lever 410 in an axial direction, the lever 410 is supported on the thrust member 470 through the knob 421 and the spacer 422 and the flange 425.

FIG. 21B shows a view of the spacer 422 and a part of the thrust member of the master cylinder 400 of FIG. 20 from the direction of piston 340, the other parts being omitted for the sake of clarity.

To adjust the handlebar width, the turning knob 421 opposite the spacer 422 that is held in rotationally fixed fashion between the two extensions 471, 472 of the rotary piece 470 is turned to shift the relative position between turning knob 421 and collar 423. As a result, the handlebar width is adjusted.

The exemplary embodiment according to FIGS. 20 to 21B also has an adjusting device for the idle travel and/or pressure point. For this purpose, the spindle 430 is turned in a sleeve 433 that is connected with a bolt 412 for rotation therewith through pins 434, the bolt 412 being disposed in the support of the thrust member 470. For the purpose of rotation, the spindle 430 has a tool engagement portion 435. By turning the spindle 430 the distance is thus adjusted between sleeve 433 and the collar 432, which defines the idle travel 436.

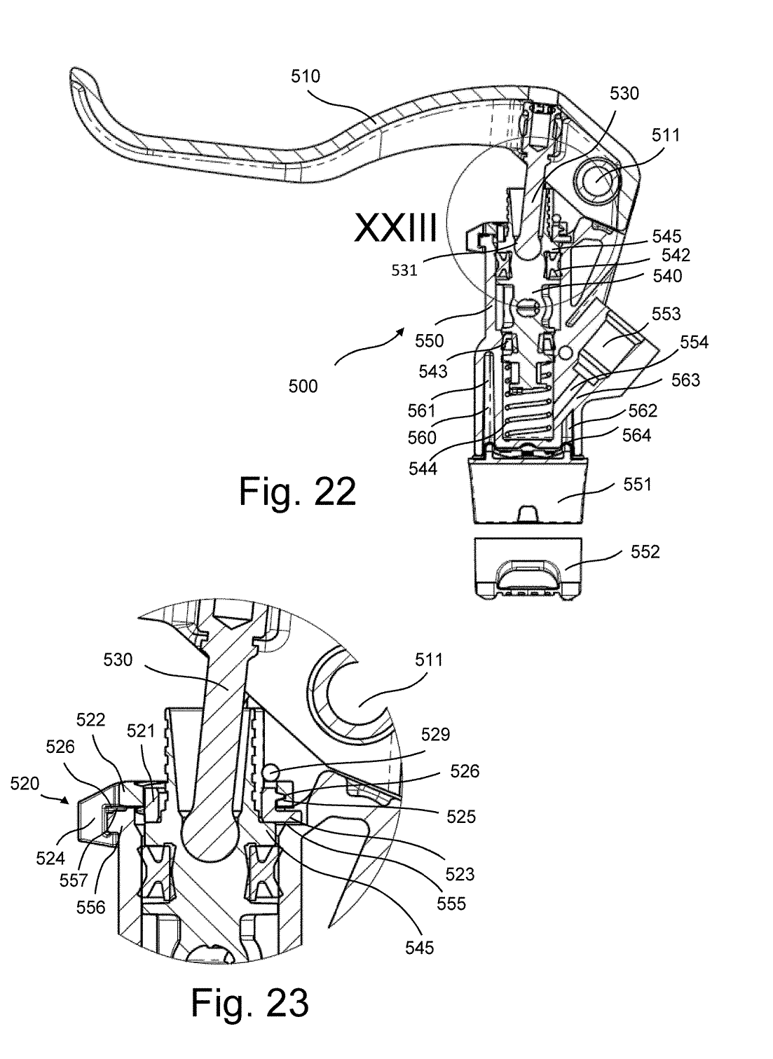

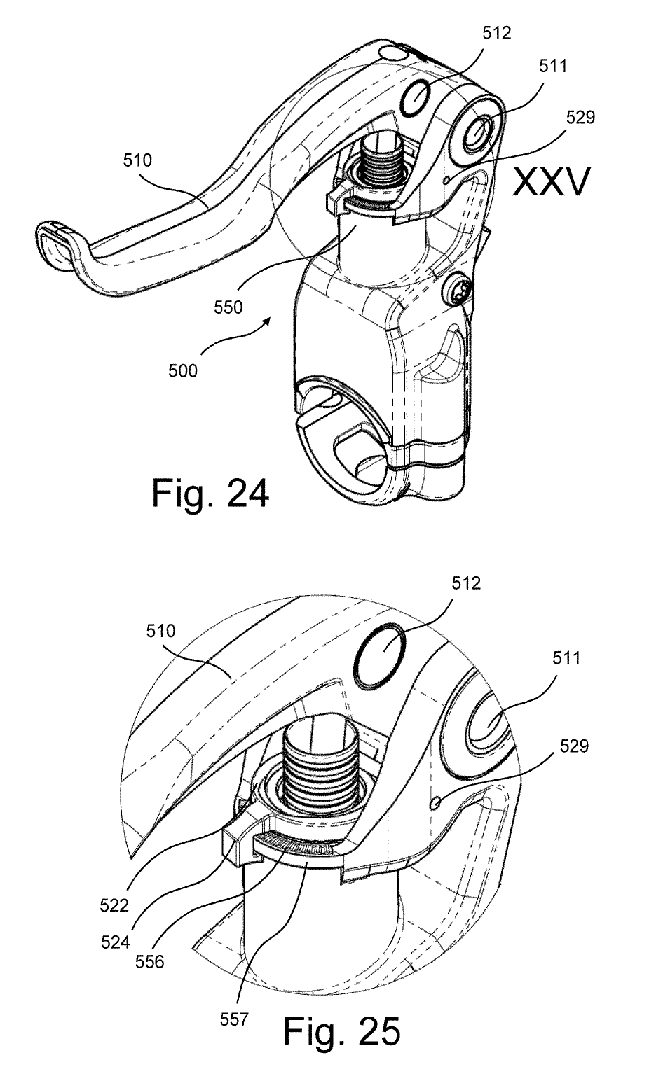

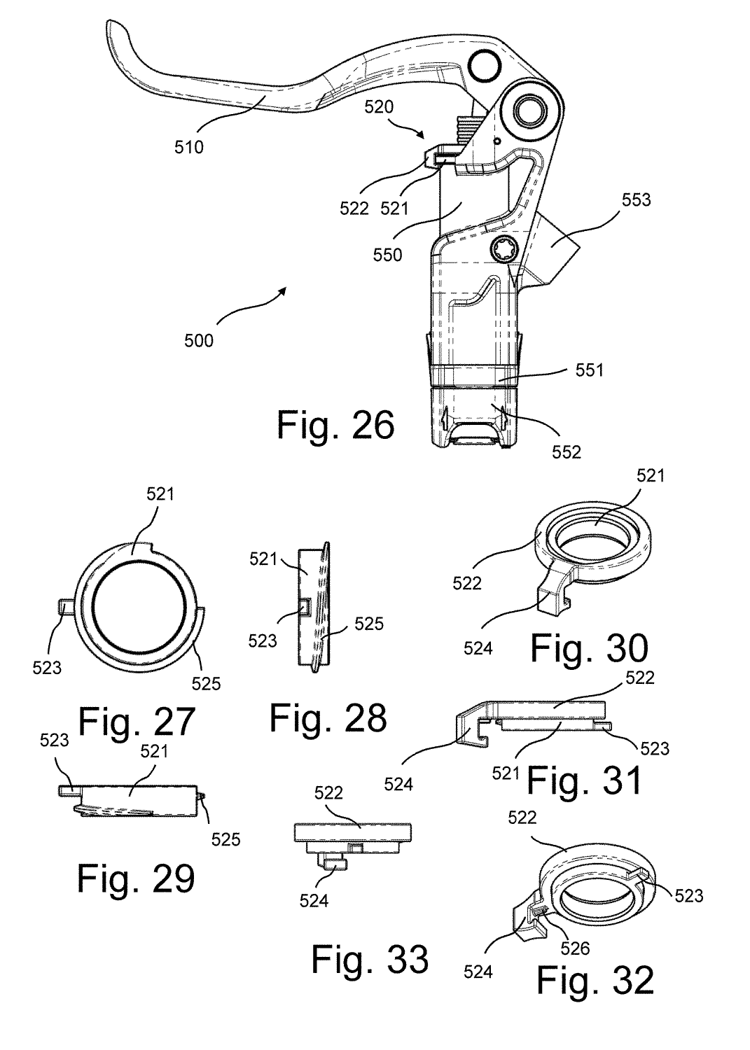

FIGS. 22 to 32 show a further exemplary embodiment of a master cylinder 500 of a hydraulic brake or clutch. The embodiment of FIGS. 22 to 33 corresponds substantially to the embodiments shown and described in FIGS. 18 to 19 and/or 20 to 21B. Equal components have equal reference numbers that are increased by 200 with respect to the embodiment of FIGS. 18 to 19 and by 100 with respect to the embodiment of FIGS. 20 to 21B. Only the difference with respect to the embodiments shown in FIGS. 18 to 19 and/or 20 to 21 is described below. Reference is also made to the other description and, in particular, to the description of the exemplary embodiments of FIGS. 18 to 19 and 20 to 21B.

The master cylinder 500 described in FIGS. 22 to 33 according to an exemplary embodiment can be used in combination with a hydraulic brake or hydraulic clutch, in particular, in the case of a handlebar steered vehicle, e.g., a bicycle or motorcycle.

The master cylinder 500 shown in FIGS. 22 to 33 has an adjusting device 520 for adjusting the limit stop of piston 540. Piston 540 is slidably received in a cylinder bore in the housing 550. A head 541 of a spindle 530 is locked in a support. The spindle 530 is connected with a lever 510 that is rotatably supported about a bolt 511. The piston 540 has a collar 545 that defines the end position of the piston 540 in the master cylinder 500 by its stop against the adjusting device 520.

The adjusting device 520 has a stop part 521 that comprises an extension 523 that meshes with a support 555 of the housing 550. The stop part 521 is disposed in the housing 550 in rotationally fixed fashion. For this purpose, the extension 523 is received in the support 555 of the housing 550. The side of the stop part 521 opposite the collar 545 of piston 540 here serves as a stop surface that defines the rotary position and/or the orientation of the piston 540 in the housing 550 of the master cylinder 500. The piston 540 is shown in its end position in the figures, which means that the piston 540 abuts against the stop part 521 through collar 545. The extension 523 is disposed in the support 555 so that it can move in an axial direction of the piston but not in the circumferential direction of the piston. The stop part 521 has a flange including an external thread 525. The external thread 525 comprises a turn of approximately three quarters of a rotation, which means less than one pitch. The adjusting device 520 also comprises an actuating link 522 that has an internal thread 526 corresponding to the external thread 525, where the external thread 525 of the stop part 521 is accommodated. The actuating link 522 comprises an actuating member 524 that the user can grab to turn the adjusting link 522 relatively to the stop part 521 about the piston axis. As a result, the relative position of the stop part 521 is changed in the actuating link 522, which defines the end position of piston 540.

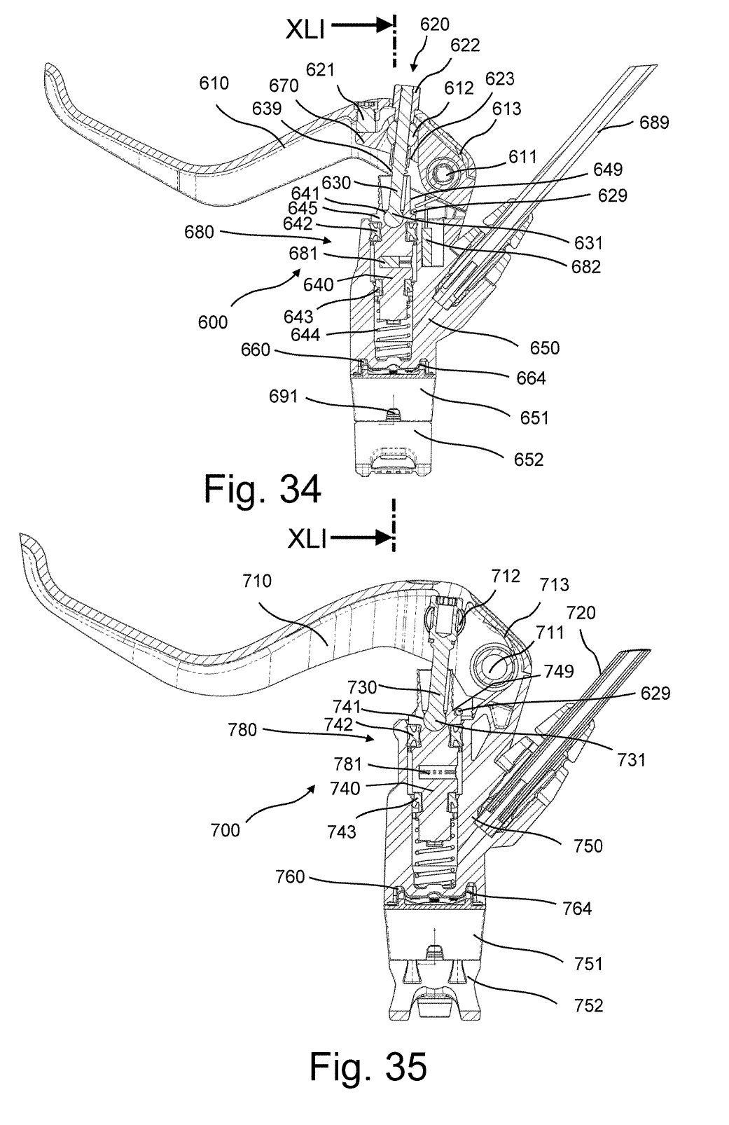

The actuating link 522 engages with the actuating member 524 behind a collar 557 of the housing. The actuating link 522 is secured on the opposite side by a pin 529 in opposition to the actuating direction when the master cylinder 500 is actuated. The pin 529 is supported in the housing. In the region of pin 529, the piston can also have a flattening (as shown in the embodiment according to FIGS. 34, 41 and 42) so that the piston 540 is disposed in a clear rotary position in the housing 550 to facilitate the detection of the position of the piston 540.

The actuating link 522 has a projection 526 that engages a locking device 556 provided on the collar 557 to prevent an intended adjustment of the adjusting device. To actuate the adjusting device 520, a force is required sufficient to move the projection 526 beyond the locking device 556. By rotating the adjusting link 522 about the axis of piston 540, the thread is turned between the actuating link 522 and the spacer 521 so as to move the spacer 521 relative to the actuating link 522 and thus relative to the pin 529 and the collar 557, i.e., relative to the housing 550 in an axial direction of the piston 540 so as to change the end position of the piston 540.

FIGS. 34 and 35 show further exemplary embodiments of a master cylinder 600, 700 of a hydraulic brake or clutch.

The embodiment of FIG. 34 corresponds, in particular, substantially to the embodiment shown and described in the figures. Equal components are designated by equal reference numbers, which are increased by 200 with respect to the embodiment of FIGS. 20 to 21B. Only the difference to the embodiment according to FIGS. 20 to 21B is described below. In addition, reference is made to the other description and, in particular, to the description of FIGS. 20 to 21B.

The master cylinder 600 according to FIG. 34 has an adjusting device 620 for the handlebar width. A spacer 621 is screwed into the lever 610 and is supported on the thrust member 670. As a result, the relative position, i.e., the angle between the thrust member 670 and the lever 610, is adjusted based on the bolt 611. Irrespective of the adjustment of the handlebar width, the pressure point and/or the idle travel can be adjusted by the actuating link 622, which moves the spindle 630 into the bolt 612 that is received in the thrust member 670. In this connection, the idle travel is adjusted between a sleeve 623 connected with the spindle 630 for rotation therewith and the bolt 612. The sleeve 623 here has an internal thread that cooperates with an external thread provided on the spindle 630. The maximum adjustability is limited by a stop 639 that is formed as a collar disposed at the spindle 630.

The pin 629 is disposed in the housing and defines a fixed rotary position of the piston 640 within which the pin 629 glides along a surface or flattening 649 formed at the piston 640 when the master cylinder 600 is actuated.

The pin 629 defines the end position of the piston 640 in the housing 650. In the embodiment shown, the pin 629 is made of steel and has a thickness of about 1.5 mm. The connection between the head 631 of the spindle 630 and the support 641 in the piston 640 is provided as a predetermined breaking point so that the pin 629 does not bend in spite of its small dimensions (diameter 1.5 mm). Strong forces can occur in the case of a fall, for example, where the lever 610 is turned outwards in opposition to the actuating direction.

Because the surface or flattening 649 is or has a flattened surface in the outer region of the piston 640, the pin 629 abutting against this flattening 649 and/or surface defines the rotary position of the piston. The advantage is that the relative position of the piston 640 in an axial direction, i.e., the extent of actuation, can be detected more easily. In particular, it is not absolutely necessary to provide a piston position detection device 680 that, irrespective of the rotary position of the piston 640 in the cylinder bore, can detect the position of the piston 640, i.e., the position of the piston 640 in an axial direction, i.e., a measure for the actuation of the master cylinder 600. For example, the piston position detection device 680 can comprise a magnet 681 that cooperates with a sensor 682 to detect the axial position of the piston 640 in the cylinder bore of the housing 650. When the piston 680 is held by the pin 629 in a certain rotary position, the magnet 681 can be a rod magnet. The magnet 681 is, for example, press-fitted transversely in the piston 640 and is flush with the circumferential surface of the piston 640 and/or cast therewith. The magnet 681 is, for example, disposed as close as possible to the circumferential surface of the piston 640 to enable the best possible signal generation. The sensor 682 can comprise a reed contact and/or a Hall sensor, for example. Other devices known to the person skilled in the art for the detection of an axial position of a component slidably disposed in a bore are conceivable.

According to an exemplary non-illustrated embodiment, it is also possible to provide a clip that secures the head 631 of the spindle 630 in the support 641 of the piston 640. The advantage is that the spring 644 can be omitted, if desired, or can have a smaller spring constant because the lever 610 returns the piston 640 into a rest position when the spring 613 is made correspondingly strong, for example. It might be disadvantageous that the predetermined break point is omitted that is formed by the head 631 of the spindle 630, which is disposed in the support 641.

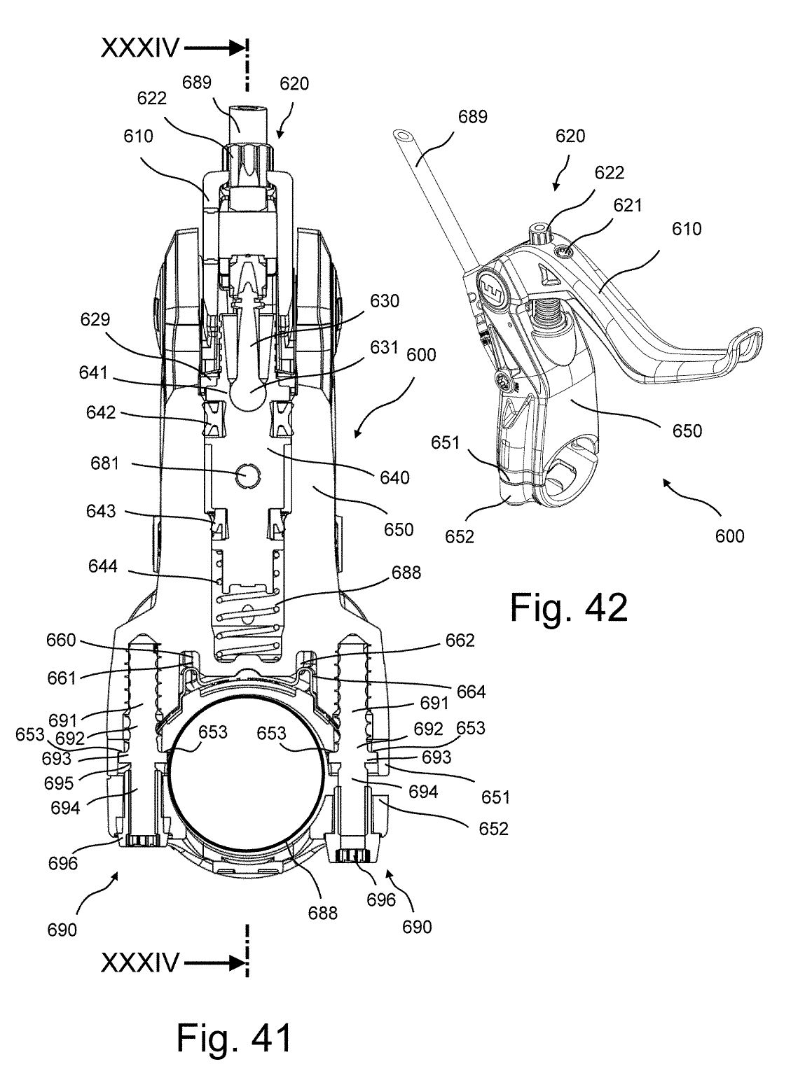

FIG. 41 shows a cross-sectional view of the master cylinder of FIG. 34 along line XLI-XLI of FIG. 34. FIG. 41 shows, in particular, the attachment of the master cylinder 600 at a handlebar tube 688. The master cylinder 600 has two connecting devices 690 that comprise stud bolts. The connecting devices 690 have a first connecting portion 691 that is screwed into a corresponding bore in the housing 650. A press fit can also be provided in place of a screw connection. A bush can also be provided in the housing into which the first connecting portion 691 is press-fitted or screwed or adhered. A pin and/or bolt can also be provided in the housing on which the first connecting portion 691 is screwed or pressed or adhered (with a corresponding hollow portion.

The connecting device 690 has a collar 693 that presses the cover 651 against the housing 650 as soon as the connecting device 690 is attached to the housing 650 and the collar 693 touches the stop 653 to limit a further or deeper engagement of the connecting device 690 into the housing 650. To seal the housing 650 with respect to the cover 651 and/or the compensation chamber 660, the bellows 664 can be clamped with its edge (see e.g. FIG. 14, reference number 232) between the housing 650 and the cover 651. The compensation chamber 660 and the bellows 664 can advantageously be formed as in the design shown in FIGS. 11 to 17. This also applies to the other embodiments of master cylinders that are described in the present disclosure.

The connecting device 690 has a special tool engagement 695. By a special non-illustrated tool, it is possible to attach the connecting device 690 to the housing 650. In this form, the master cylinder 600 can be sold to the customer and/or user. One advantage provided by this is that an unintended wrong assembly can be prevented.

The connecting device 690 has a second connecting portion 694. The counterpart 652 has recesses for receiving the second connecting portions 694. To attach the counterpart 652 to the connecting device 690, attachment nuts 696 are provided that are screwed onto the second connecting portion 694 in a manner known to the person skilled in the art. In the connection between the counterpart 652 and the cover 651 and/or the housing 650, the handlebar tube 688 is clamped between the cover 651 and the counterpart 652.

The master cylinder 600 has a spring 613 that is, for example, formed as a leg spring. The spring 613 biases the thrust member 670 to the outside about the bolt 611 and/or the fulcrum defined by the bolt with respect to the housing 650. This leads to the advantage that the spring 613 subjectively eliminates the clearance for the user, i.e., the idle travel between the bolt 612 and the sleeve 623 that the user has to travel over upon actuation before the spindle 630 is moved downwards in the direction of the piston 640 when the brake or clutch lever 610 is actuated. In other words, the spring 613 biases the thrust member 670 outwardly such that the idle travel between bolt 612 and sleeve 623 must fully be traveled over upon actuation and the lever 610 and/or the thrust member 670 does not “waggle”. At the same time, the spring 613 biases the thrust member 670 with respect to the lever 610 and/or the handlebar adjusting device 620 outwards so that there is no clearance either but the lever 610 always abuts against the thrust member 670 via the handlebar adjusting device 620. The spring 613 thus has a dual function in that the spring 613 biases the thrust member 670 to the outside, on the one hand (to create the idle travel upon actuation, which defines the pressure point), and biases the thrust member 670 with respect to the brake lever 610 to the outside, on the other hand, to avoid a clearance in the handlebar adjusting device 620.

Alternatively to the leg spring 613 as shown, it is also possible to provide another spring device that also forces and/or biases the housing 650 away from the thrust member 670. For example, a pressure spring can be disposed on a side opposite with respect to the fulcrum and/or the bolt 612 of the spindle 630.

The embodiments of FIGS. 34, 41 and 42 also has the advantage that the handlebar width can be adjusted irrespective of the pressure point.

FIG. 35 shows a further exemplary embodiment of the invention that substantially corresponds to the embodiment of FIG. 34. The corresponding parts are designated with equal reference numbers that are increased by 100. Only the differences with respect to the configuration of FIG. 34 are described below and, as for the rest, reference is made to the description thereof.

The embodiment of FIG. 35 differs from the embodiment of FIG. 34 to the effect that only a handlebar width adjustment is provided while an adjustment of the pressure point is not provided. The handlebar width is achieved by turning the spindle 730 in the bolt 712. In the embodiment of FIG. 35, only the signal member 781 is shown. The sensor is not shown in this sectional view. The sensor is provided in the housing 750 next to the signal member 781. The anti-twist protection of the piston 740 is achieved in the embodiment of FIG. 35 in that the piston 740 has a flattening 749 where the pin 729 abuts in the rest position of the piston 740. As a result, the piston 740 is returned to the starting position times and again in the rest position. Because no forces act on the piston 740 in the peripheral direction, twisting of the piston 740 can be prevented with sufficient safety by this temporal orientation of the piston 740.

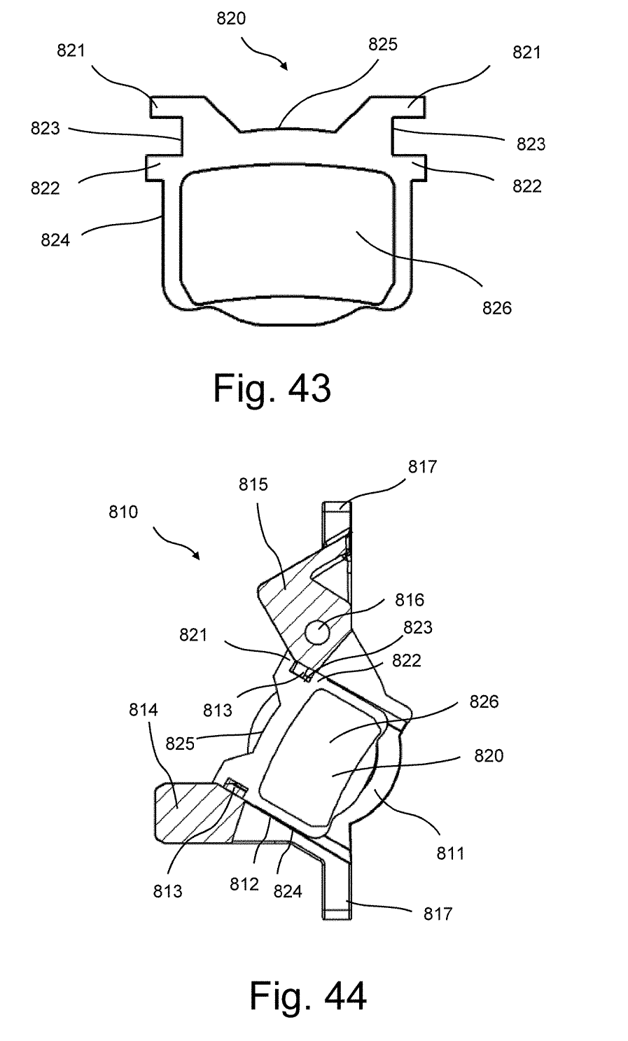

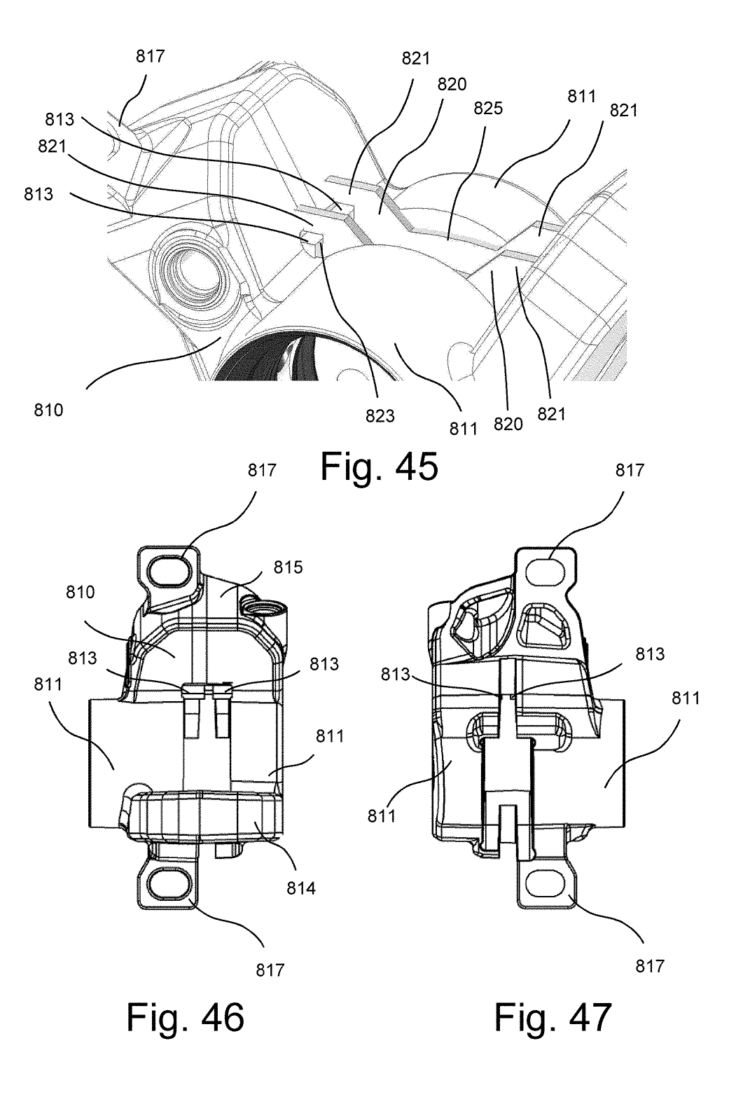

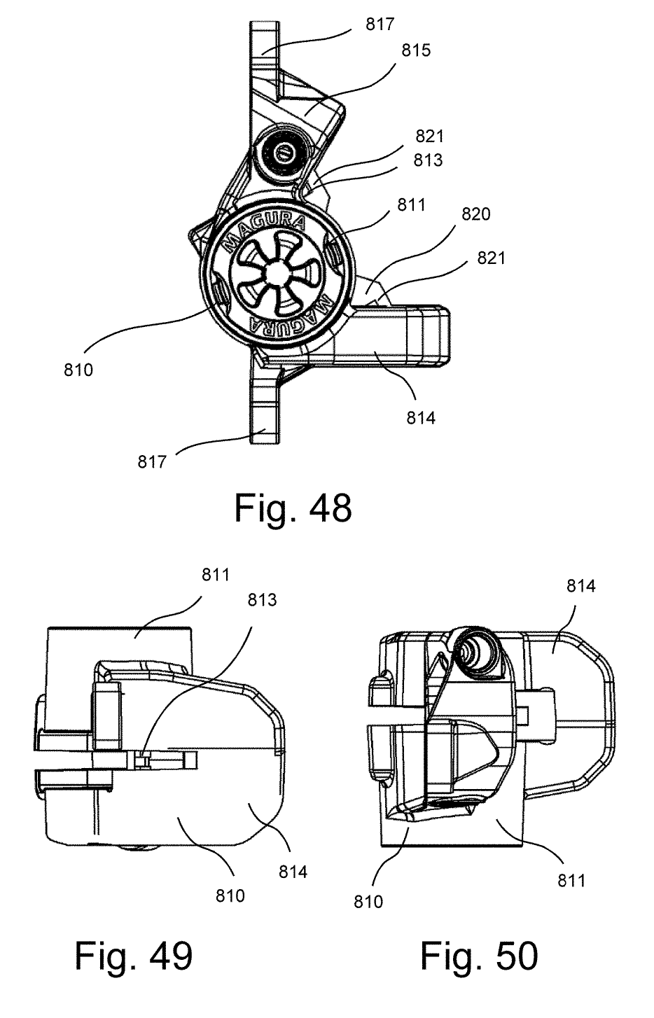

FIGS. 43 to 50 show a brake caliper 810 with a brake pad 820 according to a further exemplary embodiment. These embodiments of the invention show a special feature in the mounting of the brake pads 820 on the brake caliper 810.

On their upper side, the brake pads 820 have extensions 821, 822 that laterally protrude in pairs. A recess 823 is provided between the two extensions 821, 822 of each pair, in which a track can engage to hold the brake pad 820. Because such a recess 823 is provided on both sides of the brake pad 820, a safe support of the brake pad can be achieved by a support on both sides.

The brake pad 820 also has a friction pad 826 that is mounted and composed in a way known to the person skilled in the art. The brake pad 820 has abutment surfaces 824 on the sides, by which the brake pad 820 can support on the brake caliper 810 while braking.

On its top side, the brake pad 820 has a recess 825 between the two upper extensions 821. This recess 825 serves for reducing the weight and is not provided in other embodiments of the invention.

The brake caliper 810 has a pair of brake cylinders 811 that enclose a duct accommodating the brake pads 820. On its sides, the duct has brake pad abutment surfaces 812 on which the brake pads 820 abut while braking.

The brake caliper 810 has a disk chamber for receiving a brake disk (not shown). To increase the rigidity, stiffening members 814 and/or 815 are provided on both sides. As to their function, reference is made to the description of the other figures and the exemplary embodiments of the present application.

The figures also show the hydraulic channel 816 and the coupling portions 817 for attaching the brake caliper 810 to a frame portion and/or a fork of a bicycle.

A brake pad support 813 is provided above the duct and/or above the brake pad abutment surfaces 812. The brake pad support 813 is an intermittent track provided on both sides of the duct above the brake pad abutment surfaces 812. The brake pad support 813 is intermittent in the center, i.e., in the plane where the brake disk is disposed when the brake is assembled, i.e., the brake pad support 813 extends on both sides of this plane.

This embodiment has the advantage that the brake pad 820 can easily be mounted or changed in the brake caliper 810.

For the purpose of assembly, the brake pad 820 is pushed into the duct of the brake caliper 810 from below, i.e., from a direction where the brake disk would be in the case of a mounted brake caliper 810. As is known, the brake disk must be removed when the brake pads are built in the brake calipers. Because the brake pad support 813 is removed in the plane of the brake disk, the brake pad 820 can be disposed in the plane of the brake disk in front of the brake pad support 813 and then be pushed laterally onto the brake pad support 813. As soon as a brake pad 820 has been pushed to one side, the other brake pad 820 can be pushed onto the opposite side. The two brake pads 820 can thus be hung like a coat-hanger onto a clothes rail without it being necessary to remove the coat-hanger (i.e., the bolt which secures the brake pad), as it exists in the case of the prior art. As soon as the brake disk is disposed again in the duct and thus between the brake pads 820, the brake disk secures the brake pads in the brake caliper against falling off because the brake pads 820 have to be moved to the plane of the brake disk for the purpose of disassembly and/or exchange. However, this plane is blocked by the brake disk. A spring device 930 (e.g., see FIG. 54) can additionally be provided as an additional protection and to avoid undesired knocking and sliding noise, the spring device 930 biasing the brake pads towards the respective brake pistons away from the brake disk.

Provision of the brake pad support above the duct and/or above the disk chamber of the brake caliper 810 has a further advantage that the brake caliper 810 can be produced in a particularly cost-effective way because several brake calipers can be produced with a tool at the same time. This is the case because the moldings do not have to be removed in different directions while being removed from the mold.

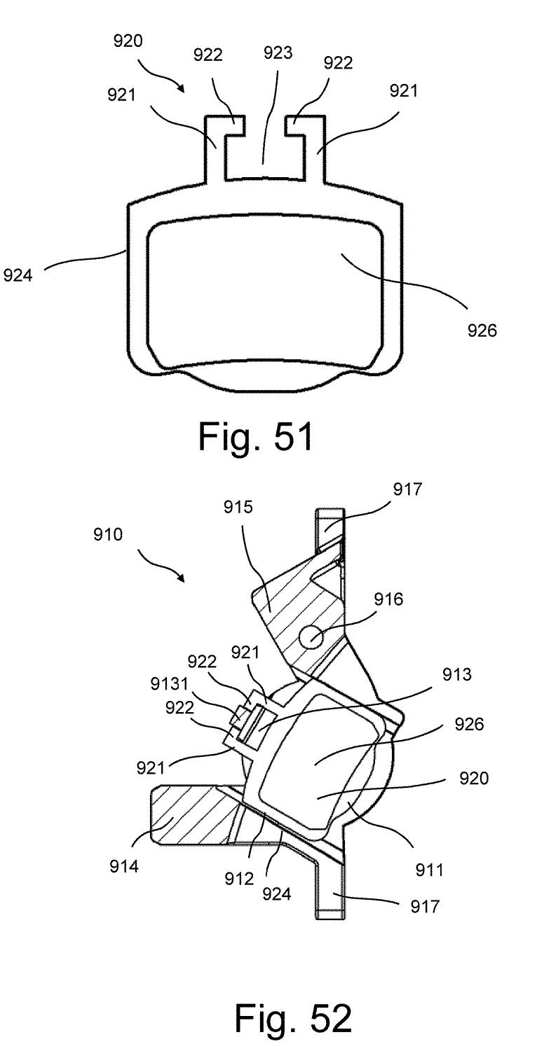

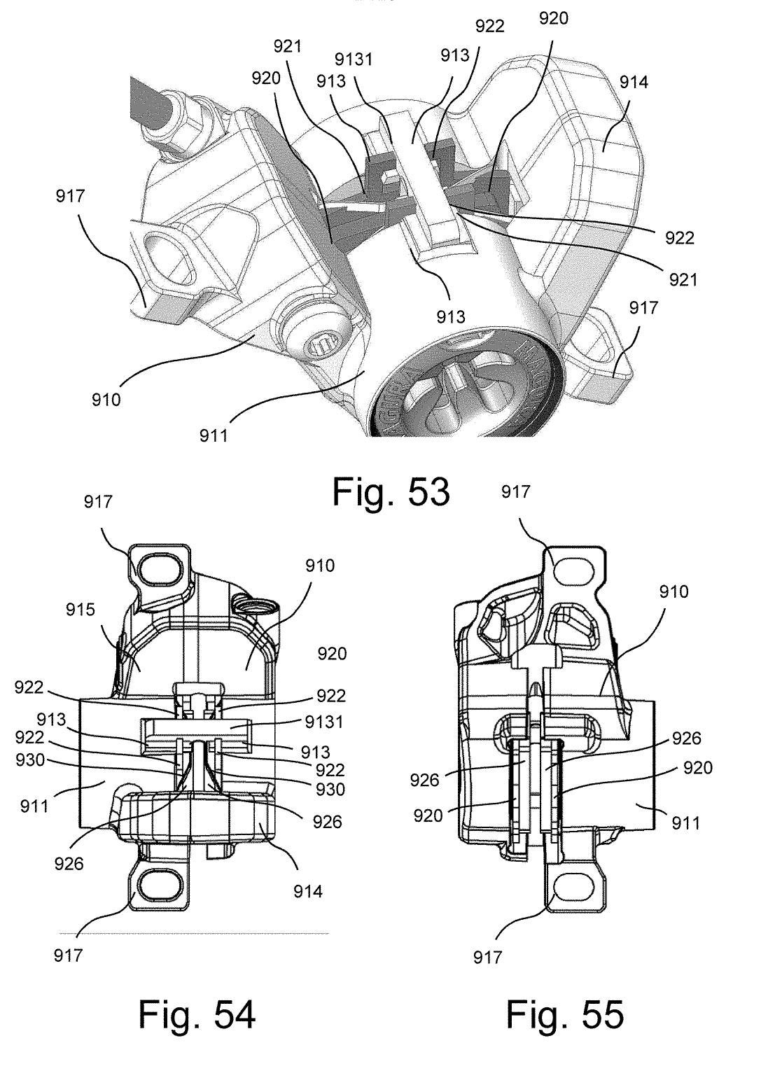

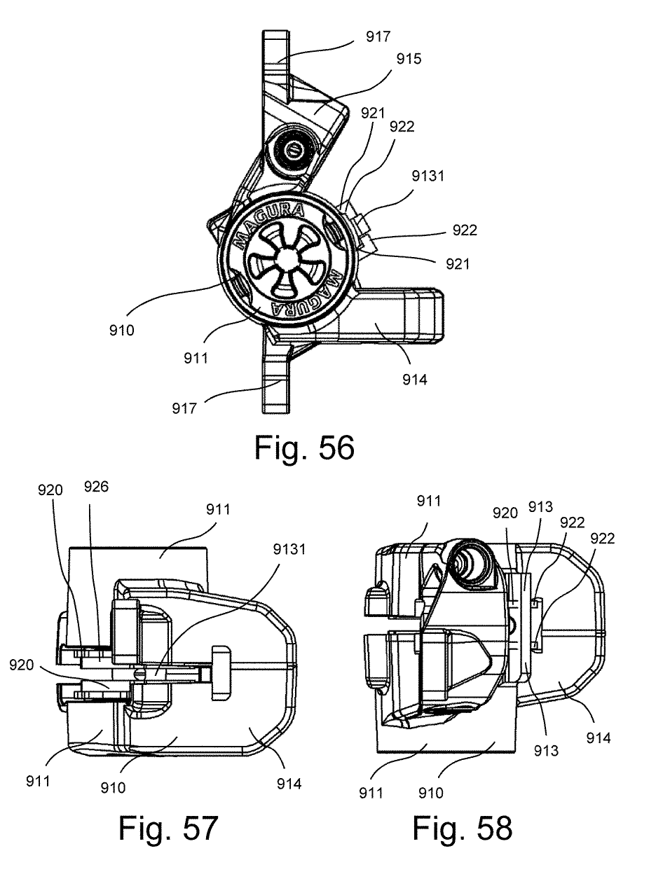

FIGS. 51 to 58 show a brake caliper 910 with a brake pad 920 according to a further exemplary embodiment. These embodiments of the invention also have a special feature as regards the attachment of the brake pads 920 at the brake caliper 910.

The two embodiments according to FIGS. 43 to 50 and/or 51 to 58 are similar. Therefore, the differences of the embodiments are described above all below and, as for the rest, reference is made to the description of the other embodiment. Similar and/or corresponding or equal parts are designated with equal reference numbers which are, however, increased by 100.

On its top side, the brake pad 920 has extensions 921 that extend upwards in pairs and have further extensions 921 each of which approach one another. Due to these extensions 921, 922, a hook pair is thus formed that can engage around a track disposed in the recess 923 formed by the hook pair. The brake caliper 910 has a corresponding brake pad support 913 above the disk chamber and/or the duct, the support 913 being discontinued in the center. In the embodiment shown, the two brake pad supports 913 are connected with each other through a connecting ridge 9131 that extends in a way like a bridge from one brake pad support 913 to the opposite brake pad support 913.

According to an exemplary non-illustrated embodiment, the connecting ridge 9131 can be omitted. In such a case, the two extensions 922 could be connected with each other so that the brake pad supports 913 are enclosed by the thus-formed ring. As in the other embodiments of the invention, the brake pad supports have an integral construction with the brake caliper 910, for example, by the molding tool. Due to the divided configuration (i.e., in the plane of the brake disk) and the configuration above the disk chamber, there are the described advantages of a simple assembly and/or a simple exchange of the brake pads and also a simple construction of the brake caliper.

### REFERENCE NUMERALS USED HEREIN

1 brake disk configuration
10 adapter (center lock adapter or central adapter)
11 internal gearing
12 carriers (burls)
13 shoulder
20 brake disk
21 recess
22 opening
23 brake band
24 struts
25 opening
26 outer contour
30 connecting link (circlip)
31 connecting member (hook)
32 securing member (burl)
33 ring
34 extension
40 screw (center lock screw)
41 external thread
42 spur gearing
43 tool engagement
44 tool engagement
110 brake caliper
111 hydraulic coupling bore
112 hydraulic channel
113 connecting portion
114 pressure chamber
115 internal thread portion
116 closure
117 coupling portion
118 brake caliper cylinder
119 piston
1191 brake pad
120 brake line
130 coupling link
131 annular head
132 connecting channel
133 sleeve
134 gasket (e.g. O-ring)
135 gasket (e.g. O-ring)
140 connecting link
141 connecting region
142 external gearing
143 connecting portion
145 external thread portion
146 circumferential groove
147 tool engagement portion
151 direction of the axis of the brake caliper cylinder 118
152 direction of the hydraulic coupling bore 111
153 direction perpendicular to direction 151 of the axis of the brake caliper cylinder 118
154 direction of the coupling link 130
181 stiffening link (e.g. bracket)
182 stiffening link (e.g. bracket without hydraulic coupling)
191 direction of the stiffening link 181 in the plane of the disk chamber
192 direction of the stiffening link 182 in the plane of the disk chamber
193 center of the cylinder chamber receiving the piston
200 master cylinder
210 master housing
211 compensation chamber
211A compensation chamber portion
211B compensation chamber portion
211C compensation chamber portion
211D compensation chamber portion
212A compensation bore
212B compensation bore
212C compensation bore
212D compensation bore
213 ridge
214 rib
215 recess
220 cylinder chamber (or piston chamber, i.e. in place of the term cylinder chamber it is also possible to use the term piston chamber. The cylinder chamber or piston chamber designates the space in the master cylinder where the piston is slidably arranged. This applies to the entire present disclosure, in particular also to the other exemplary embodiments, the general description and the claims).
222A opening of the compensation bore into the cylinder chamber
222B opening of the compensation bore into the cylinder chamber
222C opening of the compensation bore into the cylinder chamber
222D opening of the compensation bore into the cylinder chamber
230 bellows
231A extension
231B extension
231C extension
231D extension
232 edge
233 area
234 bulge
300 master cylinder
310 lever or brake lever or clutch lever
311 fulcrum or bolt
312 bolt
313 spring
314 nut
320 actuating member
321 internal gearing
322 gearing
323 spring
330 spindle
331 ball head
332 collar
333 lower portion
334 upper portion
335 gearing
340 piston
341 support
342 gasket
343 gasket
344 spring
350 housing of the master cylinder
351 housing cover
352 counterpart
353 filling opening
354 channel
360 compensation chamber
361 compensation chamber portion
362 compensation chamber portion
363 ridge
364 bellows
380 locking sleeve
381 gearing
382 external thread
400 master cylinder
410 lever or brake lever or clutch lever
411 fulcrum or bolt
420 adjusting device for the handlebar width
421 turning knob
422 spacer
423 collar
424 extension
425 flange
430 spindle
431 head
432 collar
433 sleeve
434 pin
435 tool engagement portion
436 idle travel
440 piston
441 support
442 gasket
443 gasket
444 spring
450 housing
451 cover
452 counterpart
453 filling opening
454 channel
460 compensation chamber
461 compensation chamber portion
462 compensation chamber portion
463 ridge
464 bellows
470 thrust member
471 extension
472 extension
500 master cylinder
510 lever or brake lever or clutch lever
511 bolt or fulcrum
520 adjusting device piston stop
521 stop part (with housing, rotationally fixed)
522 adjusting part (opposite to stop part 521, turnable)
523 extension
524 actuating link
525 thread
526 thread
527 protrusion
529 pin
530 spindle
540 piston
541 support
542 gasket
543 gasket
544 spring
545 collar
550 housing
551 cover
552 counterpart
553 filling opening
555 support
556 locking means
557 collar
600 master cylinder
610 lever or brake lever or clutch lever
611 bolt or fulcrum
612 bolt
613 spring
620 adjusting device
621 spacer
622 actuating link
623 sleeve
629 pin
630 spindle
631 head
639 stop (e.g. collar)
640 piston
641 support
642 gasket
643 gasket
644 spring
649 flattening and/or surface
650 housing
651 cover
652 counterpart (e.g. clamp)
653 stop (for collar (693) of the connecting device 690)
660 compensation chamber
661 compensation chamber portion
662 compensation chamber portion
664 bellows
670 thrust member
680 sensor device
681 magnet (e.g. rod magnet)
682 sensor (e.g. reed contact or Hall sensor)
688 handlebar tube
689 brake line
690 connecting device
691 stud bolt
692 thread portion (for fixing the stud bolt in the housing 650)
693 collar
694 thread portion (for fixing connecting means for attaching the counterpart 652 to the cover 651 and/or with the housing 650 to the handlebar tube 688)
695 special tool engagement
696 mounting nut
700 master cylinder
710 lever or brake lever or clutch lever
711 bolt or fulcrum
712 bolt
720 adjusting device
721 tool engagement portion
729 pin
730 spindle
731 head
740 piston
741 support
742 gasket
743 gasket
744 spring
750 housing
751 cover
752 counterpart
760 compensation chamber
764 bellows
780 sensor device
781 magnet
810 brake caliper
811 brake cylinder
812 brake pad abutment surface
813 brake pad support (track)
814 stiffening member
815 stiffening member
816 hydraulic channel
817 coupling portion
820 brake pad
821 extension
822 extension
823 recess
824 abutment surface
825 recess
826 friction pad
910 brake caliper
911 brake cylinder
912 brake pad abutment surface
913 brake pad support (track)
9131 connecting ridge
914 stiffening member
915 stiffening member
916 hydraulic channel
917 coupling portion
920 brake pad
921 extension
922 extension
923 recess
924 abutment surface
926 friction pad
930 spring device

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A master cylinder for a hydraulic brake or clutch, comprising:
a lever and a cylinder housing in which a piston is slidably arranged, wherein the piston is secured against rotation in the cylinder housing; and
a piston position detection device having:
a signal member asymmetrically arranged with respect to a circumference of the piston; and
a detection member that is at least one of:
assigned to the signal member; and
opposite to the signal member.

2. The master cylinder according to claim 1, wherein the signal member is a bar magnet.

3. The master cylinder according to claim 1, wherein the detection member is a Hall sensor.

4. The master cylinder according to claim 1, wherein the detection member is a reed contact.

5. The master cylinder according to claim 1, wherein the signal member is press-fitted transversely in the piston.

6. The master cylinder according to claim 1, wherein the signal member is flush with a circumferential surface of the piston.

7. The master cylinder according to claim 1, wherein the signal member is cast with the piston.

8. The master cylinder according to claim 1, wherein a surface or flattening is formed at the piston.

9. The master cylinder according to claim 8, wherein a pin is arranged in the housing and defines a fixed rotary position of the piston.

10. The master cylinder according to claim 9, wherein the pin glides along the surface or flattening formed at the piston when the master cylinder is actuated.

11. The master cylinder according to claim 9, wherein the pin defines the end position of the piston in the housing.

12. The master cylinder according to claim 9, wherein the pin is made of steel.

13. The master cylinder according to claim 8, wherein the surface or flattening is one of:
a flattened surface; or
has a flattened surface,
in an outer region of the piston.

14. A hydraulic bicycle brake comprising the master cylinder according to claim 1, wherein the hydraulic bicycle brake is a hydraulic bicycle disk brake.
